(19) United States
(12) Patent Application Publication
(10) Pub. No.: US 2022/0110141 A1
(43) Pub. Date: Apr. 7, 2022

(54) SIDELINK TRANSMISSION FROM RELAY USER EQUIPMENT (UE) TO REMOTE UE

(71) Applicant: QUALCOMM INCORPORATED, San Diego, CA (US)

(72) Inventors: Yongjun Kwak, San Diego, CA (US); Seyedkianoush Hosseini, San Diego, CA (US); Jing Lei, San Diego, CA (US); Hung Dinh Ly, San Diego, CA (US); Yuchul Kim, San Diego, CA (US); Hwan Joon Kwon, San Diego, CA (US)

(21) Appl. No.: 17/447,726

(22) Filed: Sep. 15, 2021

Related U.S. Application Data
(60) Provisional application No. 63/198,215, filed on Oct. 2, 2020.

(51) Int. Cl. H04W 72/12; H04W 52/02

(52) U.S. Cl. CPC H04W 72/1278; H04W 88/04; H04W 52/0229

(57) ABSTRACT

Wireless communications systems and methods related to sidelink transmissions from a relay user equipment (UE) to a remote UE are provided. For example, a first UE receives, from a second UE, a configuration indicating a set of resource regions spaced apart from each other in time. The first UE monitors, in one or more of the resource regions, for sidelink control information. The first UE receives, from the second UE based on the monitoring, the sidelink control information in a first resource region of the set of the resource regions. The first UE receives, from the second UE based on the sidelink control information, sidelink data.

### CROSS-REFERENCE TO RELATED APPLICATIONS

The present application claims priority to and the benefit of U.S. Provisional Application No. 63/198,215, filed Oct. 2, 2020, the entirety of which is hereby incorporated by reference.

### TECHNICAL FIELD

This present disclosure is directed to wireless communication systems and methods. Certain embodiments can enable and provide techniques for sidelink transmissions from a user equipment (UE) to a remote UE.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the long term evolution (LTE) technology to a next generation new radio (NR) technology, which may be referred to as 5^{th} Generation (5G). For example, NR is designed to provide a lower latency, a higher bandwidth or a higher throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

In a wireless communication network, a BS may communicate with a UE in an uplink direction and a downlink direction. Sidelink was introduced in LTE to allow a UE to send data to another UE without tunneling through the BS and/or an associated core network. The LTE sidelink technology had been extended to provision for device-to-device (D2D) communications, vehicle-to-everything (V2X) communications, and/or cellular vehicle-to-everything (C-V2X) communications. Similarly, NR may be extended to support sidelink communications, D2D communications, V2X communications, and/or C-V2X over licensed bands and/or unlicensed bands.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

For example, in an aspect of the disclosure, a method of wireless communication performed by a first user equipment (UE), the method includes receiving, from a second UE, a configuration indicating a set of resource regions spaced apart from each other in time; monitoring, in one or more of the resource regions, for sidelink control information; receiving, from the second UE based on the monitoring, the sidelink control information in a first resource region of the set of resource regions; and receiving, from the second UE based on the sidelink control information, sidelink data.

In an additional aspect of the disclosure, a method of wireless communication performed by a first user equipment (UE), the method includes transmitting, to a second UE, a configuration indicating a set of resource regions spaced apart from each other in time; transmitting, to the second UE, sidelink control information in a first resource region of the set of resource regions; and transmitting, to the second UE based on the sidelink control information, sidelink data.

In an additional aspect of the disclosure, a first user equipment (UE) includes at least one processor configured to monitor, in one or more resource regions of a set of resource regions, for sidelink control information; and a transceiver configured to receive, from a second UE, a configuration indicating the set of resource regions spaced apart from each other in time; receive, from the second UE based on the monitoring, the sidelink control information in a first resource region of the set of resource regions; and receive, from the second UE based on the sidelink control information, sidelink data.

In an additional aspect of the disclosure, a first user equipment (UE) includes a transceiver configured to transmit, to a second UE, a configuration indicating a set of resource regions spaced apart from each other in time; transmit to the second UE, the sidelink control information in a first resource region of the set of resource regions; and transmit, to the second UE based on the sidelink control information, sidelink data.

In an additional aspect of the disclosure, an apparatus for wireless communications by a first user equipment (UE) includes: a memory and at least one processor configured to: obtain, from a second UE, a configuration indicating a set of resource regions spaced apart from each other in time; monitor, in one or more of the set of the resource regions, for sidelink control information; obtain, from the second UE based on the monitoring, the sidelink control information in a first resource region of the set of the resource regions; and obtain, from the second UE based on the sidelink control information, sidelink data.

In an additional aspect of the disclosure, an apparatus for wireless communications by a first user equipment (UE) includes: a memory and at least one processor configured to: provide, for transmission to a second UE, a configuration indicating a set of resource regions spaced apart from each other in time; providing, for transmission to the second UE, sidelink control information in a first resource region of the set of the resource regions; and provide, for transmission to the second UE based on the sidelink control information, sidelink data.

In an additional aspect of the disclosure, a non-transitory computer-readable medium has program code recorded thereon, the program code is executable by a first user equipment (UE) and includes code for receiving, by the first UE from a second UE, a configuration indicating a set of resource regions spaced apart from each other in time; code for monitoring, by the first UE in one or more resource regions of the set of resource regions, for sidelink control information; and code for receiving, by the first UE from the second UE based on the monitoring, the sidelink control information in a first resource region of the set of resource regions; and code for receiving, by the first UE from the second UE based on the sidelink control information, sidelink data.

In an additional aspect of the disclosure, a non-transitory computer-readable medium has program code recorded thereon, the program code is executable by a first user equipment (UE) and includes code for transmitting, by the first UE to a second UE, a configuration indicating a set of resource regions spaced apart from each other in time; code for transmitting, by the first UE to the second UE, the sidelink control information in a first resource region of the set of resource regions; and code for transmitting, by the first UE to the second UE based on the sidelink control information, sidelink data.

In an additional aspect of the disclosure, a first user equipment (UE) includes means for receiving, from a second UE, a configuration indicating a set of resource regions spaced apart from each other in time; means for monitoring, in one or more resource regions of the set of resource regions, for sidelink control information; and means for receiving, from the second UE based on the monitoring, the sidelink control information in a first resource region of the set of resource regions; and means for receiving, from the second UE based on the sidelink control information, sidelink data.

In an additional aspect of the disclosure, a first user equipment (UE) includes means for transmitting, to a second UE, a configuration indicating a set of resource regions spaced apart from each other in time; means for transmitting, to the second UE, the sidelink control information in a first resource region of the set of resource regions; and means for transmitting, to the second UE based on the sidelink control information, sidelink data.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 illustrates a wireless communication network according to some aspects of the present disclosure.

FIG. 2 illustrates a wireless communication network that provisions for sidelink communications according to some aspects of the present disclosure.

FIG. 3 illustrates a sidelink communication scheme according to some aspects of the present disclosure.

FIG. 4 illustrates a sidelink deployment scenario according to some aspects of the present disclosure.

FIG. 5 illustrates a sidelink deployment scenario according to some aspects of the present disclosure.

FIG. 6 illustrates a sidelink communication scheme for forward link operations according to some aspects of the present disclosure.

FIG. 7 illustrates is a sidelink communication scheme according to some aspects of the present disclosure.

FIG. 8 illustrates is a sidelink communication scheme according to some aspects of the present disclosure.

FIG. 9 is a sequence diagram illustrating a sidelink communication method according to some aspects of the present disclosure.

FIG. 10 is a block diagram of an exemplary user equipment (UE) according to some aspects of the present disclosure.

FIG. 11 is a block diagram of an exemplary base station (BS) according to some aspects of the present disclosure.

FIG. 12 is a flow diagram of a communication process according to some aspects of the present disclosure.

FIG. 13 is a flow diagram of a communication process according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various embodiments, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with a ultra-high density (e.g., ˜1M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

A 5G NR communication system may be implemented to use optimized OFDM-based waveforms with scalable numerology and transmission time interval (TTI). Additional features may also include having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with UL/downlink scheduling information, data, and acknowledgement in the same subframe. The self-contained integrated subframe supports communications in unlicensed or contention-based shared spectrum, adaptive UL/downlink that may be flexibly configured on a per-cell basis to dynamically switch between UL and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

Sidelink communications refers to the communications among user equipment devices (UEs) without tunneling through a base station (BS) and/or a core network. Sidelink communication can be communicated over a physical sidelink control channel (PSCCH) and a physical sidelink shared channel (PSSCH). The PSCCH and PSSCH are analogous to a physical downlink control channel (PDCCH) and a physical downlink shared channel (PDSCH) in downlink (DL) communication between a BS and a UE. For instance, the PSCCH may carry sidelink control information (SCI) and the PSSCH may carry sidelink data (e.g., user data). Each PSCCH is associated with a corresponding PSSCH, where SCI in a PSCCH may carry reservation and/or scheduling information for sidelink data transmission in the associated PSSCH. In some implementations, the SCI in the PSCCH may referred to as SCI part 1 (SCI-1), and additional SCI, which may be referred to as SCI part 2 (SCI-2) may be carried in the PSSCH. The SCI-2 can include control information (e.g., transmission parameters, modulation coding scheme (MCS)) that are more specific to the data carrier in the PSSCH. Use cases for sidelink communication may include V2X, enhanced mobile broadband (eMBB), industrial IoT (IIoT), NR-lite, and/or NR-super-lite. NR-lite may refer to a reduced-version of NR in terms of UE power consumptions, capabilities, and/or cost. NR-super-lite may refer to a further reduced-version of NR in terms of UE power consumptions, capabilities, and/or cost.

As used herein, the term “sidelink UE” can refer to a user equipment device performing a device-to-device communication or other types of communications with another user equipment device independent of any tunneling through the BS (e.g., gNB) and/or an associated core network. As used herein, the term “sidelink transmitting UE” can refer to a user equipment device performing a sidelink transmission operation. As used herein, the term “sidelink receiving UE” can refer to a user equipment device performing a sidelink reception operation. As used herein, the terms “sync UE”, “sidelink sync UE”, “anchor UE”, or “sidelink anchor UE” refer to a sidelink UE transmitting an S-SSB to facilitate sidelink communications among multiple sidelink UEs (e.g., when operating in a standalone sidelink system), and the terms are interchangeable without departing from the scope of the present disclosure. As used herein, the terms “relay UE” or “sidelink relay” refers to a UE within the coverage of a BS functioning as a relay node between the BS and another UE. As used herein, the term “remote UE” refers to a UE communicating with a BS via a relay UE. A sidelink UE may operate as a transmitting sidelink UE at one time and as a receiving sidelink UE at another time. A sidelink sync UE, a relay UE, or a remote UE may also operate as a transmitting sidelink UE at one time and operate as a receiving sidelink UE at another time.

NR supports two modes of radio resource allocations (RRA), a mode-1 RRA and a mode-2 RRA, for sidelink over a licensed spectrum. The mode-1 RRA supports network controlled RRA that can be used for in-coverage sidelink communication. For instance, a serving BS (e.g., gNB) may determine a radio resource on behalf of a sidelink UE and transmit an indication of the radio resource to the sidelink UE. In some aspects, the serving BS grants a sidelink transmission with downlink control information (DCI). For this mode, however, there is significant base station involvement and is only operable when the sidelink UE is within the coverage area of the serving BS. The mode-2 RRA supports autonomous RRA that can be used for out-of-coverage sidelink UEs or partial-coverage sidelink UEs. For instance, a serving BS may configure a sidelink UE (e.g., while in coverage of the serving BS) with sidelink resource pools which may be used for sidelink when the sidelink UE is out of the coverage of the serving BS. A serving BS may also configure a sidelink UE to operate as a sidelink anchor UE to provide sidelink system information for out-of-coverage sidelink UEs to communicate sidelink communications. For instance, a sidelink anchor UE may provide sidelink system information by broadcasting sidelink-synchronization signal block (S-SSB). The S-SSB may be analogous to the SSB broadcast by a BS. For instance, an S-SSB may include synchronization signals and/or sidelink system information. Some examples of sidelink system information may include a sidelink bandwidth part (BWP) configuration, one or more sidelink transmit resource pools, and/or one or more sidelink receive resource pools, S-SSB transmission related parameters (e.g., sidelink slots configured for S-SSB transmission and/or S-SSB transmission periodicity), and/or any other configuration information related to sidelink communications. In some implementations, an anchor UE may also schedule other sidelink UEs for communications. Thus, a sidelink anchor UE may operate as a mini-gNB facilitating and/or coordinating communications among sidelink UEs over. A sidelink channel where two UEs may communicate with each other directly may also be referred to as a PC5 interface.

The advancement in wireless communication technologies such as NR, had been mostly focused on delivering high-end services (e.g., eMBB) to premium smartphones, which may have high processing and/or power capabilities, and/or services (e.g., URLLC and V2X) for vertical industries. To address scalability, NR-lite had been introduced to enable a more efficient and cost-effective deployment, for example, by relaxing (lowering) the peak data throughput, latency, and/or reliability. Thus, NR-lite may be more suitable for serving mid-end UEs that that may have lower capabilities than the premium UEs. As use cases and diverse deployment scenarios continue to expand in wireless communication, further complexity and/or power consumption reduction may enable the support of low power wide area (LPWA) deployments. For instance, NR-super-lite with further reduced capabilities may support low-end UEs that may have lower capabilities than the mid-end UEs. Some examples use cases for NR-super-lite may include delivery of services related to smart metering, asset tracking, and/or personal IoT applications (e.g., health monitoring). Accordingly, there is a need to improve coverage, complexity, and/or power consumption.

In some aspects, a network may utilize sidelink to improve coverage, power consumption and/or complexity for low-end UEs. For example, in some use cases, the sidelink transmission may support UE-to-network relay, in which an in-coverage UE is able to relay signals between a gNB and an out-of-coverage UE (remote UE). Using the relay UE to relay communications between the gNB and the remote UE can improve power efficiencies by avoiding a large number of radio signal repetitions (e.g., up to 2048 repetitions) that may otherwise be required to extend coverage. In some instances, the remote UE may measure the received-signal-indicator (RSSI) level from the gNB, and if the RSSI is below a pre-defined threshold, the remote UE may connect to the in-coverage relay UE. Subsequently, the in-coverage relay UE may receive data and control signaling from the gNB, boost signal power, and transmit them to the sidelink remote UE. In some instances, the remote out-of-coverage UE may be in the same cell as the sidelink relay UE. In some other instances, the remote UE may be in a different cell than the sidelink relay UE.

In some use cases, the sidelink transmission may be utilized to support short distance communications such as wearable or in home new wearable. For example, in short distance sidelink communications, a sidelink UE (a relay) may be utilized to support relaying signals from a gNB to several low power wearable devices. Additionally, in some uses cases, the sidelink relay may be utilized to support a low power operational mode in some technologies such as vehicle-to-everything (V2X) systems. V2X systems enables vehicles to communicate with the traffic and environment around then using short distance communications. The sidelink relay, may be utilized in V2X system to reduce power consumption of the communication devices connected to a sidelink relay.

In some aspects, a sidelink UE may support half-duplex communications. In other words, the sidelink UE may perform transmission or reception at any given time, but not both transmission and reception at the same time. Thus, the total amount of resources in a sidelink resource pool is shared between transmission and reception. One issue with half-duplex communication is that when a sidelink UE is transmitting in a sidelink resource, the sidelink UE may not be able to monitor other sidelink resources at the same time. As such, if another sidelink UE transmits SCI in one of the other resources indicating a reservation for a future sidelink resource, the UE may not detect the SCI, and thus may not be aware of the reservation. If the UE determines to transmit in the reserved sidelink resource, the UE can cause a collision or interference and impact sidelink performance.

In some aspects, a sidelink resource pool may include a set of sidelink resources (e.g., time-frequency resources). Each sidelink resource may include a PSCCH and a PSSCH. A transmitting sidelink UE may transmit a sidelink transmission using one of the sidelink resources from the resource pool. The sidelink transmission may include SCI (in a PSCCH of a sidelink resource) and sidelink data (in a PSSCH of the sidelink resource. The SCI may indicate control information, such as a destination identifier (ID) identifying a receiving sidelink UE for the sidelink data transmission being transmitted, and/or a reservation for a future sidelink resource. Thus, a receiving sidelink UE or monitoring UE may perform SCI sensing or monitoring in the sidelink resource pool to determine whether there is data addressed to the receiving sidelink UE or not. If the receiving sidelink UE detected SCI (in a PSCCH of a sidelink resource) including a destination ID identifying the receive sidelink UE, the receiving sidelink UE may proceed to receive corresponding sidelink data (in a PSSCH of the sidelink resource). In some aspects, a sidelink UE may continuously monitor for SCI in the sidelink resource pool to determine whether there is data for the receiving sidelink UE or a reservation for a future sidelink resource whenever the sidelink UE is not performing a sidelink transmission. SCI monitoring can be power consuming, and thus it may not be desirable for a low-end sidelink UE to perform frequent SCI monitoring.

The present application describes mechanisms for sidelink transmission from a relay UE to a remote UE with power-efficient SCI monitoring at the remote UE. A forward link may refer to a sidelink in a transmission direction from a relay UE to a remote UE. A reverse link may refer to a sidelink in a transmission direction from a remote UE to a relay UE. For example, a relay UE may transmit to a remote UE over a sidelink a configuration indicating a set of SCI monitoring resource regions spaced apart from each other in time. In some other instances, the configuration for the set of SCI monitoring resource regions may be provided to the relay UE by a base station (BS). The remote UE may receive the configuration and monitor for SCI only in the SCI monitoring resource regions instead of performing SCI monitoring whenever the remote UE is not performing a sidelink transmission. Thus, the set of SCI monitoring resource regions being spaced apart in time can provide the remote UE with opportunities to save power. As discussed above, SCI may carry control information to facilitate a receiving UE in receiving and/or demodulating PSSCH data. For instance, the relay UE may transmit to the remote UE, the SCI over a SCI monitoring resource region. Accordingly, the remote UE may monitor the SCI monitoring resource region and receive the SCI from the relay UE over the SCI resource region. In some aspects, the relay UE may transmit sidelink data to the remote UE according to the SCI. Accordingly, the remote UE may receive sidelink data from the relay UE based on the SCI.

In some aspects, the set of SCI monitoring resource regions may be part of a sidelink resource pool, where the sidelink resource pool may include sidelink resources, each including a PSCCH and a PSSCH. Thus, each SCI monitoring resource regions may include PSCCH resources as well as PSSCH resources. For instance, the relay UE may transmit to the remote UE, the SCI in a PSCCH resource within a first SCI monitoring resource region of the set of SCI monitoring resource regions. In some examples, the SCI may indicate or reference a PSSCH resource (where the relay UE may transmit sidelink data to the remote UE) within the first SCI monitoring resource region. Additionally or alternatively, the SCI may indicate or reference a PSSCH resource (where the relay UE may transmit sidelink data to the remote UE) outside the first SCI monitoring resource region. Accordingly, the remote UE may receive from the relay UE, the SCI in the PSCCH resource within the first SCI monitoring resource region. If the SCI indicates or references a PSSCH resource is within the first SCI monitoring resource region, the remote UE may receive from the relay UE, data in the PSSCH resource within the first monitoring resource. If the SCI indicates or references a PSSCH resource outside the first SCI monitoring resource region, the remote UE may receive from the relay UE, data in the PSSCH resource outside of the first SCI monitoring resource region.

In some aspects, the set of SCI monitoring resource regions may be within a PSCCH resource pool separate from a PSSCH resource pool, and the relay UE may transmit SCI using a PSCCH resource within a first SCI monitoring resource region of the set of SCI monitoring resource regions to indicate a PSSCH resource in the PSSCH resource pool. Accordingly, the remote UE may monitor for SCI from the relay UE in the PSCCH resource pool. Upon detecting SCI from the relay UE, the remote UE may receive data from the relay UE in a PSSCH resource within the PSSCH resource pool as indicated by the SCI.

In some aspects, to provide further power saving at the remote UE, the relay UE and/or a BS may configure the remote UE with wakeup signal (WUS) monitoring occasions. The WUS monitoring occasions may allow the remote UE to enter a sleep mode to save power (e.g., when there is no active communication between the relay UE and the remote UE) and wake up to monitor for a WUS during a WUS monitoring occasion. The WUS monitoring occasions can be configured at a time before each of the set of SCI monitoring resource regions. As such, if the relay UE has data for the remote UE, the relay UE may transmit a WUS during a WUS monitoring occasion before the first SCI monitoring resource region and transmit SCI to the remote UE during the SCI monitoring resource region. Accordingly, the remote UE may wake up during the WUS monitoring occasion and may detect the WUS. Upon detecting the WUS, the remote UE may perform SCI monitoring in the first SCI monitoring resource region. If, however, the relay UE has no data for the remote UE, the relay UE may not transmit a WUS before a following SCI monitoring resource region so that remote UE may continue to operate in the sleep mode to save power.

Aspects of the present disclosure can provide several benefits. For example, where the relay UE is an advanced UE (e.g., a high-end or mid-end UE) and the remote UE is an NR superlight UE, configuring certain time durations (in the form SCI monitoring resource regions spaced apart in time) specifically for SCI transmissions can minimize SCI monitoring operations at a remote UE. Hence, power consumption can be reduced at the remote UE. Additionally, utilizing WUS can allow the remote UE to be in a sleep mode and only wake up when the relay UE has data for the remote UE. As such, power consumption can further be reduced at the remote UE.

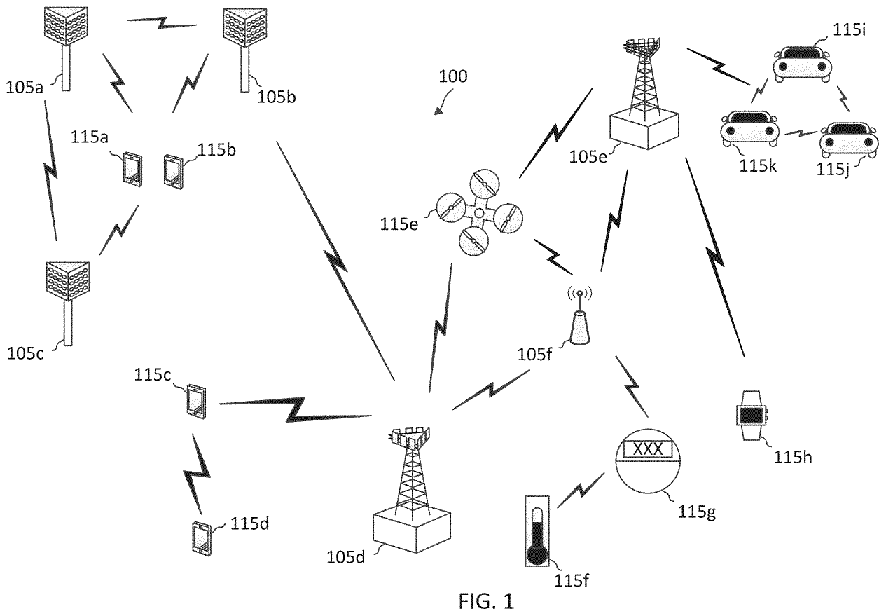

FIG. 1 illustrates a wireless communication network 100 according to some aspects of the present disclosure. The network 100 may be a 5G network. The network 100 includes a number of base stations (BSs) 105 (individually labeled as 105a, 105b, 105c, 105d, 105e, and 105f) and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-step-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as V2V, V2X, C-V2X communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some aspects, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information—reference signals (CSI-RSs) to enable a UE 115 to estimate a DL channel. Similarly, a UE 115 may transmit sounding reference signals (SRSs) to enable a BS 105 to estimate a UL channel Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some aspects, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some instances, the BSs 105 may broadcast the PSS, the SSS, and/or the MIB in the form of synchronization signal block (SSBs) over a physical broadcast channel (PBCH) and may broadcast the RMSI and/or the OSI over a physical downlink shared channel (PDSCH).

In some aspects, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI and/or the OSI, the UE 115 can perform a random access procedure to establish a connection with the BS 105. In some examples, the random access procedure may be a four-step random access procedure. For example, the UE 115 may transmit a random access preamble and the BS 105 may respond with a random access response. The random access response (RAR) may include a detected random access preamble identifier (ID) corresponding to the random access preamble, timing advance (TA) information, a UL grant, a temporary cell-radio network temporary identifier (C-RNTI), and/or a backoff indicator. Upon receiving the random access response, the UE 115 may transmit a connection request to the BS 105 and the BS 105 may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via a PUSCH and/or PUCCH according to a UL scheduling grant.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For example, the BWP pair may include one BWP for UL communications and one BWP for DL communications.

In some aspects, the network 100 may operate over a shared channel, which may include shared frequency bands or unlicensed frequency bands. For example, the network 100 may be an NR-unlicensed (NR-U) network operating over an unlicensed frequency band. In such an aspect, the BSs 105 and the UEs 115 may be operated by multiple network operating entities. To avoid collisions, the BSs 105 and the UEs 115 may employ an LBT procedure to monitor for transmission opportunities (TXOPs) in the shared channel A wireless communication device may perform an LBT in the shared channel. LBT is a channel access scheme that may be used in the unlicensed spectrum. When the LBT results in an LBT pass (the wireless communication device wins contention for the wireless medium), the wireless communication device may access the shared medium to transmit and/or receive data. For example, a transmitting node (e.g., a BS 105 or a UE 115) may perform an LBT prior to transmitting in the channel. When the LBT passes, the transmitting node may proceed with the transmission. When the LBT fails, the transmitting node may refrain from transmitting in the channel In an example, the LBT may be based on energy detection. For example, the LBT results in a pass when signal energy measured from the channel is below a threshold. Conversely, the LBT results in a failure when signal energy measured from the channel exceeds the threshold. In another example, the LBT may be based on signal detection. For example, the LBT results in a pass when a channel reservation signal (e.g., a predetermined preamble signal) is not detected in the channel. Conversely, the LBT results in a failure when a channel reservation signal is detected in the channel. A TXOP may also be referred to as channel occupancy time (COT).

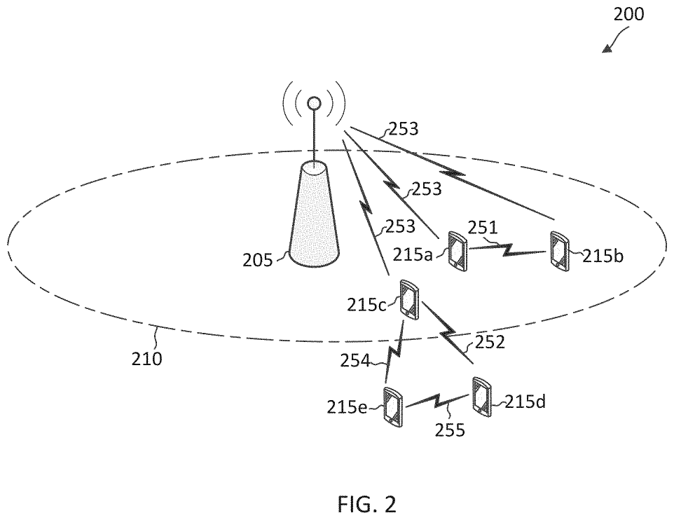

In some aspects, the network 100 may provision for sidelink communications to allow a UE 115 to communicate with another UE 115 without tunneling through a BS 105 and/or the core network as shown FIG. 2. As discussed above, sidelink communication can be communicated over a PSCCH and a PSSCH. For instance, the PSCCH may carry SCI and the PSSCH may carry SCI and/or sidelink data (e.g., user data). Each PSCCH is associated with a corresponding PSSCH, where SCI in a PSCCH may carry reservation and/or scheduling information for sidelink data transmission in the associated PSSCH. In some examples, a transmitting sidelink UE 115 may indicate SCI in two stages. In a first-stage SCI, the UE 115 may transmit SCI in PSCCH carrying information for resource allocation and decoding a second-stage SCI. The first-stage SCI may include at least one of a priority, PSSCH resource assignment, resource reservation period (if enabled), PSSCH DMRS pattern (if more than one pattern is configured), a second-stage SCI format (e.g., size of second-stage SCI), an amount of resources for the second-stage SCI, a number of PSSCH demodulation reference signal (DMRS) port(s), a modulation and coding scheme (MCS), etc. In a second-stage SCI, the UE 115 may transmit SCI in PSSCH carrying information for decoding the PSSCH. The second-stage SCI may include a-bit L1 destination identifier (ID), an 8-bit L1 source ID, a HARQ process ID, a new data indicator (NDI), a redundancy version (RV), etc. It should be understood that these are examples, and the first-stage SCI and/or the second-stage SCI may include or indicate additional or different information than those examples provided. Sidelink communication can also be communicated over a physical sidelink feedback control channel (PSFCH), which indicates an acknowledgement (ACK)-negative acknowledgement (NACK) for a previously transmitted PSSCH.

In some aspects, a BS 105 may configure a UE 115 to operate as a sidelink sync or anchor UE 115 to provide sidelink system information for other sidelink UEs 115, which may be out of the coverage of the BS 105, to communicate sidelink communications. The sidelink sync UE 115 may transmit the sidelink system information in the form of S-SSBs. An S-SSB may include synchronization signals (e.g., PSS and/or SSS) and sidelink system information, such as a sidelink BWP configuration, one or more sidelink transmit resource pools, and/or one or more sidelink receive resource pools, S-SSB transmission related parameters (e.g., sidelink slots configured for S-SSB transmission and/or S-SSB transmission periodicity), and/or any other configuration information related to sidelink communications. In some aspects, the BS 105 may configure the sidelink sync UE 115 transmit the S-SSB according to a synchronization raster defined for NR-U. In some instances, the S-SSB according to the NR-U synchronization raster may be offset from a lowest frequency of a corresponding sidelink BWP where the S-SSB is transmitted. In some other aspects, the BS 105 may transmit the S-SSB according to a synchronization raster defined for sidelink. The sidelink synchronization raster can be defined such that the S-SSB may be aligned to a lowest frequency of a corresponding sidelink BWP where the S-SSB is transmitted.

In some aspects, a UE 115 may operate as a relay sidelink UE 115 based on a pre-configuration or a configuration received from a BS 105. The relay sidelink UE 115 may communicate with at least one remote UE 115. The relay UE 115 may relay signals between the remote UE 115 and the BS 105. According to aspects of the present disclosure, the relay UE 115 may transmit a configuration indicating a set of SCI monitoring resource regions for transmitting the SCI to the remote UE 115. The set of SCI monitoring resource regions are spaced apart in time, and thus the remote UE 115 may monitor for SCI during the SCI monitoring resource regions and may operate at a lower-power mode or sleep mode at other time when there no active transmissions between the relay UE 115 and the remote UE 115. Hence, the remote UE 115 can operate with improved power efficiency.

In some aspects, the set of SCI monitoring resource regions may be part of a sidelink resource pool, where the sidelink resource pool may include sidelink resources, each including a PSCCH and a PSSCH. Thus, each SCI monitoring resource regions may include PSCCH resources as well as PSSCH resources. For instance, the relay UE 115 may transmit to the remote UE 115, the SCI in a PSCCH resource within a first SCI monitoring resource region of the set of SCI monitoring resource regions. In some examples, the SCI may reference a PSSCH resource within the first SCI monitoring resource region where the relay UE 115 may transmit sidelink data to the remote UE 115. Additionally or alternatively, the SCI may reference a PSSCH resource outside the first SCI monitoring resource region where the relay UE 115 may transmit sidelink data to the remote UE 115. Accordingly, the remote UE 115 may receive from the relay UE 115, the SCI in the PSCCH resource within the first SCI monitoring resource region. If the SCI references a PSSCH resource within the first SCI monitoring resource region, the remote UE 115 may receive from the relay UE 115, data in the PSSCH resource within the first monitoring resource. If the SCI references a PSSCH resource outside the first SCI monitoring resource region, the remote UE 115 may receive from the relay UE 115, data in the PSSCH resource outside of the first SCI monitoring resource region. In some aspects, the SCI further comprises an indication of an extended region for the first SCI monitoring resource region, and the side link relay UE 115 may monitor for another SCI during the extended region.

In some other aspects, the set of SCI monitoring resource regions may be within a PSCCH resource pool separate from a PSSCH resource pool, and the relay UE 115 may transmit SCI using a PSCCH resource within a first SCI monitoring resource region of the set of SCI monitoring resource regions to indicate a PSSCH resource in the PSSCH resource pool. Accordingly, the remote UE 115 may monitor for SCI from the relay UE 115 in the PSCCH resource pool. Upon detecting SCI from the relay UE 115, the remote UE 115 may receive data from the relay UE 115 in a PSSCH resource within the PSSCH resource pool as indicated by the SCI.

In some aspects, to provide further power saving at the remote UE 115, the relay UE 115 and/or a BS 105 may configure the remote UE 115 with wakeup signal (WUS) monitoring occasions. The WUS monitoring occasions may allow the remote UE 115 to enter a sleep mode to save power (e.g., when there is no active communication between the relay UE 115 and the remote UE 115) and wake up to monitor for a WUS during a WUS monitoring occasion. The WUS monitoring occasions can be configured at a time before each of the set of SCI monitoring resource regions. As such, if the relay UE 115 has data for the remote UE 115, the relay UE 115 may transmit a WUS during a WUS monitoring occasion before an SCI monitoring resource region and transmit SCI to the remote UE 115 during the SCI monitoring resource region. Accordingly, the remote UE 115 may detect the WUS and perform SCI monitoring in the SCI monitoring resource region. If, however, the relay UE 115 has no data for the remote UE 115, the relay UE 115 may not transmit a WUS before a following SCI monitoring resource region so that remote UE 115 may continue to operate in the sleep mode to save power.

FIG. 2 illustrates an example of a wireless communication network 200 that provisions for sidelink communications according to embodiments of the present disclosure. The network 200 may correspond to a portion of the network 100. FIG. 2 illustrates one BS 205 and five UEs 215 (shown as 215a, 215b, 215c, 215d, and 215e) for purposes of simplicity of discussion, though it will be recognized that embodiments of the present disclosure may scale to any suitable number of UEs 215 (e.g., the about 2, 3, 4, 6, 7 or more) and/or BSs 205 (e.g., the about 2, 3 or more). The BS 205 and the UEs 215 may be similar to the BSs 105 and the UEs 115, respectively. The BSs 205 and the UEs 215 may share the same radio frequency band for communications. In some instances, the radio frequency band may be a 2.4 GHz unlicensed band, a 5 GHz unlicensed band, or a 6 GHz unlicensed band. In general, the shared radio frequency band may be at any suitable frequency.

In the network 200, some of the UEs 215a-215e may communicate with each other in peer-to-peer communications. For example, the UE 215c may communicate with the UE 215e over a sidelink 254, and may communicate to UE 215d over yet another sidelink 252. The sidelinks 252, and 254 are unicast bidirectional links. Some of the UEs 215 may also communicate with the BS 205 in a UL direction and/or a DL direction via communication links 253. For instance, the UE 215a, 215b, are within a coverage area 210 of the BS 205, and thus may be in communication with the BS 205. In some instances, the UE 215c may operate as a relay for the UE 215e,215d to reach the BS 205. In some aspects, some of the UEs 215 are associated with vehicles (e.g., similar to the UEs 115i-k) and the communications over the sidelinks 252, and 254 may be C-V2X communications. C-V2X communications may refer to communications between vehicles and any other wireless communication devices in a cellular network. In some aspects, some of the UEs 215 are IoT devices such as metering devices, asset tracking devices, health monitoring devices, personal wearable devices and the communications over the sidelinks 252, and 254 may be IoT data associated with corresponding services or applications.

In some aspects, the UE 215e may serve as a sidelink anchor UE and UE 215c may serve as a sidelink receiving UE, where UE 215e transmits system parameter information including timing synchronization signals over a sidelink broadcast channel (e.g., PSBCH) such that the UE 215c can receive and recover resource allocation and timing information to facilitate a sidelink communication with the UE 215e. For purposes of explanation and brevity of discussion, the remaining description for FIG. 2 will be discussed in reference to UE 215c (e.g., sidelink receiving UE) and UE 215e (e.g., sidelink anchor UE).

Sidelink discovery of other sidelink transmitting UEs, such as other anchor nodes, can be facilitated through the use of a transport channel referred to as a transport sidelink discovery channel (SL-DCH), and its physical counterpart, the physical sidelink discovery channel (e.g., PSDCH). In some aspects, a sidelink transmitting UE can transmit one or more announcement messages that are generated using physical layer transport blocks with zero media access control overhead. For example, the UE 215e can broadcast an announcement message over the PSDCH to announce its status as an anchor node.

In various embodiments, the sidelink anchor UE may utilize the sidelink discovery procedure to: 1) announce its presence as the anchor UE to potentially proximal sidelink UEs by transmitting a message containing its application information or other useful information fields (e.g., GPS coordinates, time, and the like), and 2) monitor the presence of other proximal sidelink UEs by detecting and decoding the corresponding discovery messages, and respond to the sidelink transmitting UEs using similar discovery messages. In some instances, the discovery message may include information about the type of discovery being performed and/or the type of content (e.g., announcement, query) provided by the sidelink transmitting UE. For example, the UE 215e may broadcast a discovery message over the PSDCH, in which the discovery message includes an indication that the discovery message pertains to an announcement of its anchor node status.

In some aspects, UE 215e may perform a sensing operation on one or more of a discovery channel, such as the PSDCH, and a sidelink broadcast channel, such as the PSBCH, depending on implementation. If the UE 215e does not detect an existing anchor UE on the discovery channel, then the UE 215e may configure itself as an anchor UE and broadcast an announcement indicating itself to be the anchor UE. If the UE 215e detects an existing anchor UE, the UE 215e may determine whether there is a need for it to become an anchor node within the wireless communication network 200.

In some aspects, the UE 215e may provide a transmission resource pool configuration that includes configuration information for a discovery resource pool configuration and a control/data communication resource pool configuration. Sidelink receiving UEs (e.g., UE 215c) may monitor multiple resources to listen for discovery announcements communicated by anchor UEs (e.g., UE 215e) to minimize and/or avoid sidelink UE interference. At the end of a discovery procedure, the UE 215e and the UE 215c may establish a communication link for sidelink communication.

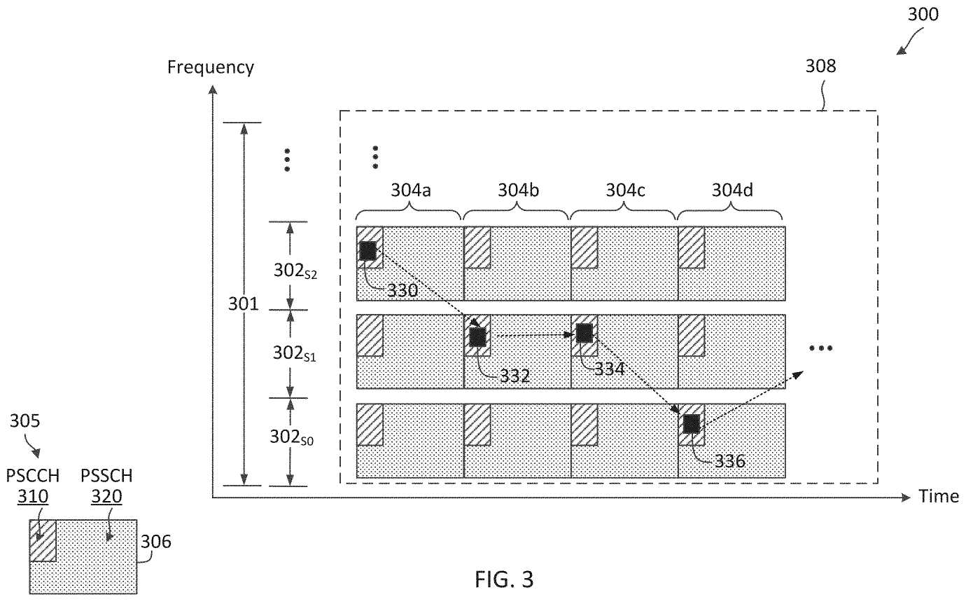

FIG. 3 illustrates a sidelink communication scheme 300 according to some aspects of the present disclosure. The scheme 300 may be employed by UEs such as the UEs 115 and/or 215 in a network such as the networks 100 and/or 200. In particular, sidelink UEs may employ the scheme 300 to communicate sidelink over a shared radio frequency band (e.g., in a shared spectrum or an unlicensed spectrum). The shared radio frequency band may be shared by multiple RATs as discussed in FIG. 2. In FIG. 3, the x-axis represents time in some arbitrary units, and the y-axis represents frequency in some arbitrary units.

In the scheme 300, a shared radio frequency band 301 is partitioned into a plurality of subchannels or frequency subbands 302 (shown as 302_{S0}, 302_{S1}, 302_{S2}, . . . ) in frequency and a plurality of sidelink frames 304 (shown as 304a, 304b, 304c, 304d, . . . ) in time for sidelink communication. The frequency band 301 may be at any suitable frequencies (e.g., at about 2.4 GHz, 5 GHz, or 6 GHz). The frequency band 301 may have any suitable BW and may be partitioned into any suitable number of frequency subbands 302. The number of frequency subbands 302 can be dependent on the sidelink communication BW requirement. The frequency band 301 may be at any suitable frequencies. In some aspects, the frequency band 301 is a 2.4 GHz unlicensed band and may have a bandwidth of about 80 megahertz (MHz) partitioned into about fifteen 5 MHz frequency subbands 302.

A sidelink UE (e.g., the UEs 115 and/or 215) may be equipped with a wideband receiver and a narrowband transmitter. For instance, the UE may utilize the narrowband transmitter to access a frequency subband 302_{S2} for sidelink transmission utilizing a frame structure 305. The frame structure 305 is repeated in each frequency subband 302. In some instances, there can be a frequency gap or guard band between adjacent frequency subbands 302 as shown in FIG. 3, for example, to mitigate adjacent band interference. Thus, multiple sidelink data may be communicated simultaneously in different frequency subbands 302 (e.g., FDM). The frame structure 305 is also repeated in time. For instance, the frequency subband 302_{S2} may be time-partitioned into a plurality of frames with the frame structure 305.

The frame structure 305 includes a sidelink resource 306 in each frequency subband 302. The sidelink resource 306 may have a substantially similar structure as an NR sidelink resource. For instance, the sidelink resource 306 may include a number of subcarriers or RBs in frequency and a number of symbols in time. In some instances, the sidelink resource 306 may have a duration between about one millisecond (ms) to about 20 ms. Each sidelink resource 306 may include a PSCCH 310 and a PSSCH 320. The PSCCH 310 and the PSSCH 320 can be multiplexed in time and/or frequency. In the illustrated example of FIG. 3, for each sidelink resource 306, the PSCCH 310 is located during the beginning symbol(s) (e.g., about 1 symbol or about 2 symbols) of the sidelink resource 306 and occupies a portion of a corresponding frequency subband 302, and the PSSCH 320 occupies the remaining time-frequency resources in the sidelink resource 306. In some instances, a sidelink resource 306 may also include a physical sidelink feedback channel (PSFCH), for example, located during the ending symbol(s) of the sidelink resource 306. In general, a PSCCH 310, a PSSCH 320, and/or a PSFCH may be multiplexed in any suitable configuration within a sidelink resource 306.

In sidelink communication, in order for the sidelink receiving UEs to successfully decode the PSCCH 310 and PSSCH 320, information describing the specific resources assigned by the sidelink anchor UE for transmission and the transmission configuration can be carried in the SCI, SCI. In this respect, control information for sidelink communication may be communicated in the form of SCI messages. The SCI message may be transmitted over the PSCCH 310, which carries the information related to the transmission of data over the PSSCH 320.

The SCI may inform the sidelink receiving UEs about a resource reservation interval, a frequency location of initial transmission and retransmission, a time gap between initial transmission and retransmission, and modulation and coding scheme (MCS) used to modulate the data transmitted over the PSSCH 320.

The SCI messages may be populated based on the modes of radio resource allocations (e.g., mode-1 RRA or mode-2 RRA). For mode-1 RRA, the SCI may be populated using higher layer information carried by L3 control signaling (e.g., RRC, and L1 control signaling configured at a cell, such as BS 205). For mode-2 RRA, the SCI may be populated based on autonomous decisions taken by each sidelink anchor UE. The structure of the SCI message may include a frequency hopping flag field, a resource block assignment and hopping resource allocation field, a time resource pattern field, MCS field, a time advance field and a group destination identifier field. The structure of the SCI message may include other additional fields that are suitable to support V2X control signaling. The frequency hopping flag field and the resource block assignment and hopping resource allocation field may provide information for the sidelink receiving UEs to identify the RBs where the data channel (e.g., PSSCH 320) resides. The sidelink anchor UE may autonomously configure each of these two fields. The identified RBs may belong to a sidelink communication resource pool (e.g., PSSCH resource pool). The time resource pattern field may provide the time-domain resource allocation for the data channel (e.g., PSSCH 320), and in particular the potential subframes used for PSSCH transmission. The MCS field may provide the MCS used for the PSSCH 320, which may be autonomously selected by the sidelink anchor UE. The timing advance field may provide a sidelink time adjustment for mode-2 RRA or other applicable mode. The group destination identifier field may indicate a group of sidelink receiving UEs that are potentially interested in the transmitted message from the sidelink anchor UE. This may be used by the sidelink receiving UE to ignore messages destined to other groups of sidelink UEs.

In some aspects, the SCI messages may be processed with transport channel encoding to generate SCI message transport blocks, which are then followed with physical channel encoding to generate corresponding PSCCH blocks. The PSCCH blocks are carried on respective subframe resource units for transmission. The sidelink receiving UE may receive one or more resource units over respective subframes to recover the control signaling information, and can extract the data channel allocation and transmission configuration.

The PSCCH 310 can be used for carrying SCI 330. The PSSCH 320 can be used for carrying sidelink data. The sidelink data can be of various forms and types depending on the sidelink application. For instance, when the sidelink application is a V2X application, the sidelink data may carry V2X data (e.g., vehicle location information, traveling speed and/or direction, vehicle sensing measurements, etc.). Alternatively, when the sidelink application is an IIoT application, the sidelink data may carry IIoT data (e.g., sensor measurements, device measurements, temperature readings, etc.). The PSFCH can be used for carrying feedback information, for example, HARQ ACK/NACK for sidelink data received in an earlier sidelink resource 306.

In some aspects, the scheme 300 is used for synchronous sidelink communication. In other words, the sidelink UEs are synchronized in time and are aligned in terms of symbol boundary, sidelink resource boundary (e.g., the starting time of sidelink frames 304). The sidelink UEs may perform synchronization in a variety of forms, for example, based on sidelink SSBs received from a sidelink UE and/or NR-U SSBs received from a BS (e.g., the BSs 105 and/or 205) while in-coverage of the BS. In some aspects, the sidelink UE may be preconfigured with the resource pool 308 in the frequency band 301, for example, while in a coverage of a serving BS according to a mode-1 RRA configuration. The resource pool 308 may include a plurality of sidelink resources 306.

In an NR sidelink frame structure, the sidelink frames 304 in a resource pool 308 may be contiguous in time. A sidelink receiving UE (e.g., the UEs 115 and/or 215) may include, in SCI 330, a reservation for a sidelink resource 306 in a later sidelink frame 304. Thus, another sidelink UE (e.g., a UE in the same NR-U sidelink system) may perform SCI sensing in the resource pool 308 to determine whether a sidelink resource 306 is available or occupied. For instance, if the sidelink UE detected SCI indicating a reservation for a sidelink resource 306, the sidelink UE may refrain from transmitting in the reserved sidelink resource 306. If the sidelink UE determines that there is no reservation detected for a sidelink resource 306, the sidelink UE may transmit in the sidelink resource 306. As such, SCI sensing can assist a UE in identifying a target frequency subband 302 to reserve for sidelink communication and to avoid intra-system collision with another sidelink UE in the NR sidelink system. In some aspects, the UE may be configured with a sensing window for SCI sensing or monitoring to reduce intra-system collision.

In some aspects, the sidelink UE may be configured with a frequency hopping pattern. In this regard, the sidelink UE may hop from one frequency subband 302 in one sidelink frame 304 to another frequency subband 302 in another sidelink frame 304. In the illustrated example of FIG. 3, during the sidelink frame 304a, the sidelink UE transmits SCI 330 in the sidelink resource 306 located in the frequency subband 302_{S2} to reserve a sidelink resource 306 in a next sidelink frame 304b located at the frequency subband 302_{S1}. Similarly, during the sidelink frame 304b, the sidelink UE transmits SCI 332 in the sidelink resource 306 located in the frequency subband 302_{S1} to reserve a sidelink resource 306 in a next sidelink frame 304c located at the frequency subband 302_{S1}. During the sidelink frame 304c, the sidelink UE transmits SCI 334 in the sidelink resource 306 located in the frequency subband 302_{S1} to reserve a sidelink resource 306 in a next sidelink frame 304d located at the frequency subband 302_{S0}. During the sidelink frame 304d, the sidelink UE transmits SCI 336 in the sidelink resource 306 located in the frequency subband 302_{S0}. The SCI 336 may reserve a sidelink resource 306 in a later sidelink frame 304.

The SCI can also indicate scheduling information and/or a destination identifier (ID) identifying a target sidelink receiving UE for the next sidelink resource 306. Thus, a sidelink UE may monitor SCI transmitted by other sidelink UEs. Upon detecting SCI in a sidelink resource 306, the sidelink UE may determine whether the sidelink UE is the target receiver based on the destination ID. If the sidelink UE is the target receiver, the sidelink UE may proceed to receive and decode the sidelink data indicated by the SCI. In some aspects, multiple sidelink UEs may simultaneously communicate sidelink data in a sidelink frame 304 in different frequency subband (e.g., via FDM). For instance, in the sidelink frame 304b, one pair of sidelink UEs may communicate sidelink data using a sidelink resource 306 in the frequency subband 302_{S2} while another pair of sidelink UEs may communicates sidelink data using a sidelink resource 306 in the frequency subband 302_{S1}.

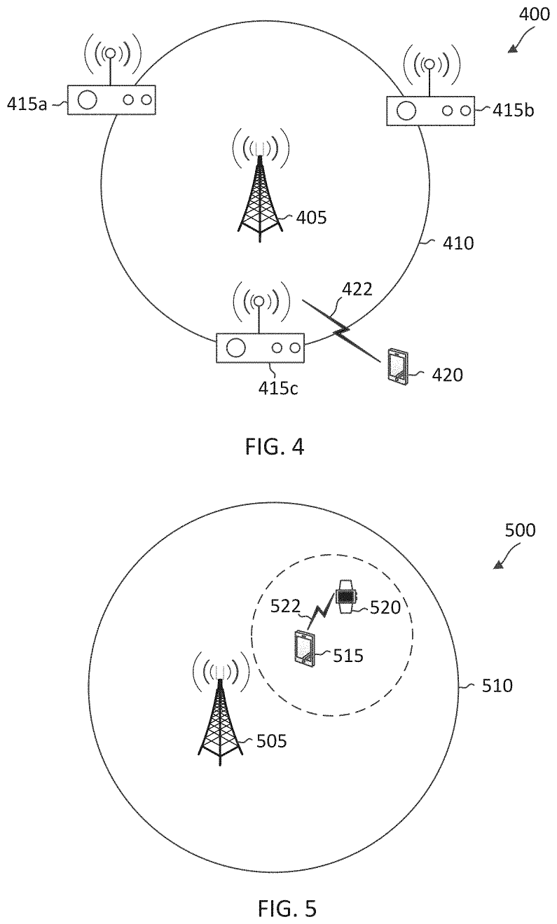

FIG. 4 illustrates a sidelink deployment scenario 400 according to some aspects of the present disclosure. The scenario 400 illustrates utilization of sidelink for coverage extension. In the scenario 400, relay UEs 415 (shown as 415a, 415b, 415c) in communication with a BS 405 are deployed to extend a coverage 410 of the BS 105. The relay UEs 415a, 415b, 415c may be similar to the UEs 115 and/or 215. The BS 405 may be similar to the UEs 115 and/or 215. Although FIG. 4 illustrates three relay UEs 415, it should be understood that in other examples a network may include any suitable number of relay UEs (e.g., about 2, 4, 5, 6, or more). The relay UEs 415 can facilitate communications between the BS 405 and UEs that are outside of the coverage area 410.

In the illustrated example of FIG. 4, the relay UE 415c operate as a relay for a remote UE 420 outside of the BS 405's coverage area 410. The remote UE 420 may be similar to the UEs 115 and/or 215. In some aspects, the relay UE 415c can be a more advanced UE than the remote UE 420. Although FIG. 4 illustrates the relay UE 415c operating as a relay for one remote UE 420, it should be understood that in other examples a relay UE can operate as a relay for any suitable number of remote UEs (e.g., about 2, 4, 5, 6, or more). The relay UE 415c may receive data and/or control information from the remote UE 420 and forward the received data and/or control to the BS 405. For instance, the data and/or control information received from the remote UE 420 are UL data and/or control information for the BS 405. The relay UE 415c may also receive data and/or control information from the BS 405 and forward the received data and/or control to the remote UE 420. For instance, the data and/or control information received from the BS 405 are DL data and/or control information for the remote UE 420. As such, the relay UE 415c can provide a communication path between the BS 405 and the UE 420 that may otherwise be unreachable by the BS 405. The communication path between the relay UE 415c and the remote UE 420 may be a PC5 interface (shown as a sidelink 422). For instance, the relay UE 415c and the remote UE 420 may communicate using sidelink channels PSSCH and/or PSCCH and/or sidelink resources as discussed above in relation to FIG. 3.

The utilization of sidelink can extend the coverage area of the BS 405 without increasing system resource utilization. For instance, without the utilization of the relay UE 415c, transmissions between the BS 405 and the remote UE 420 may require a large number of repetitions. For instance, the BS 405 may repeat each information data block, for example, about 2048 times, in a transmission before the transmission can be received by the remote UE 420. Similarly, the remote UE 420 may repeat each information data block, for example, about 2048 times, in a transmission before the transmission can be received by the BS 405. While the use of high repetitions can potentially allow the BS 405 to communicate with the remote UE 420, the use of high repetitions can increase power consumption at the remote UE 420. The high repetitions and/or high-power consumption at the remote UE 420 may not be feasible, for example, when the remote UE 420 is a low-end UE with limited processing and/or power resources. Accordingly, the deployment of the relay UE 415c allows the remote UE 420 to communicate with the relay UE 415c, which may be located at a closer distance to the remote UE 420 than the BS 405. Thus, the remote UE 420 may communicate with the relay UE 415c without consuming a large amount of power. Hence, sidelink can improve power efficiency for long-distance UL and/or DL communications. In some instances, sidelink can extend the reach or coverage by providing about a 20 decibels (dB) power boost.

FIG. 5 illustrates a sidelink deployment scenario 500 according to some aspects of the present disclosure. The scenario 500 illustrates utilization of sidelink for short-range, low-power sidelink communication, for example, for wearable or in-home network. In the scenario 500, a relay UE 515 in communication with a BS 505 is deployed to operate as a central hub or anchor UE for a remote UE 520. The BS 505 may be similar to the UEs 115 and/or 215. The relay UE 515 and/or the remote UE 520 may be similar to the UEs 115 and/or 215. However, the relay UE 515 can be a more advanced UE than the remote UE 420. For instance, the relay UE 515 may be a high-end UE or a mid-end UE, whereas the remote UE 420 may be a low-end UE (e.g., personal wearable devices, health monitoring devices, and/or like). Although FIG. 5 illustrates one relay UE 515 serving one remote UE 520, it should be understood that in other examples a network may include any suitable number of relay UEs (e.g., about 2, 3, 4, 5, 6, or more) serving any suitable number of remote UEs (e.g., about 2, 3, 4, 5, or more).

Similar to the scenario 400, the relay UE 515 may communicate with the remote UE 520 via a sidelink 522. However, the remote UE 520 may or may not have communication link established with the BS 505, for example, depending on the device types and/or applications in use. In some other instances, a V2X or D2D system may be deployed in a scenario similar to the scenario 500.

As can be seen from the scenarios 400 and 500, sidelink can be utilized to improve power efficiency, for example, for NR-super-lite where the focus is low-power operations for low-end UEs.

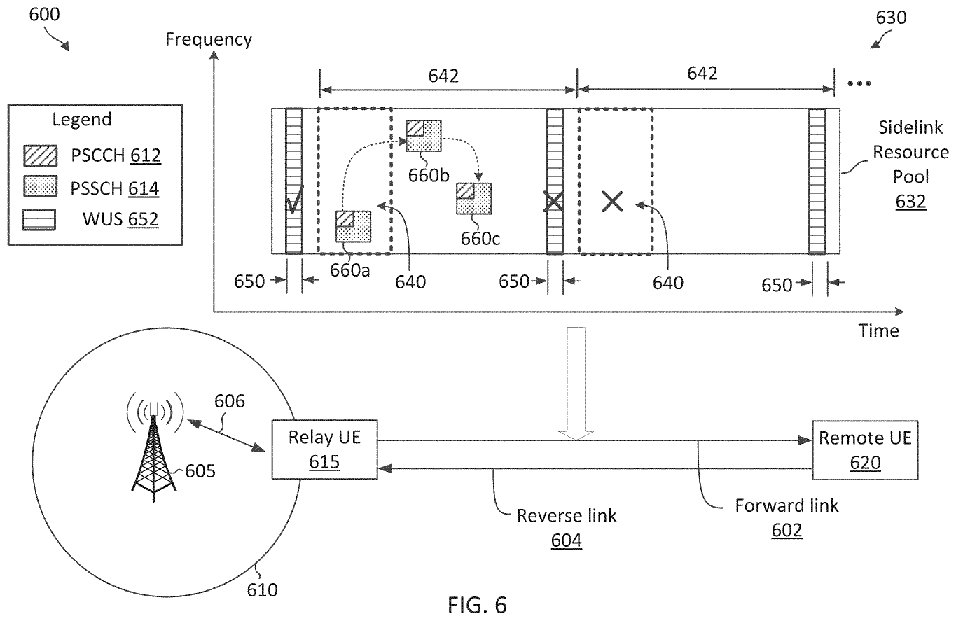

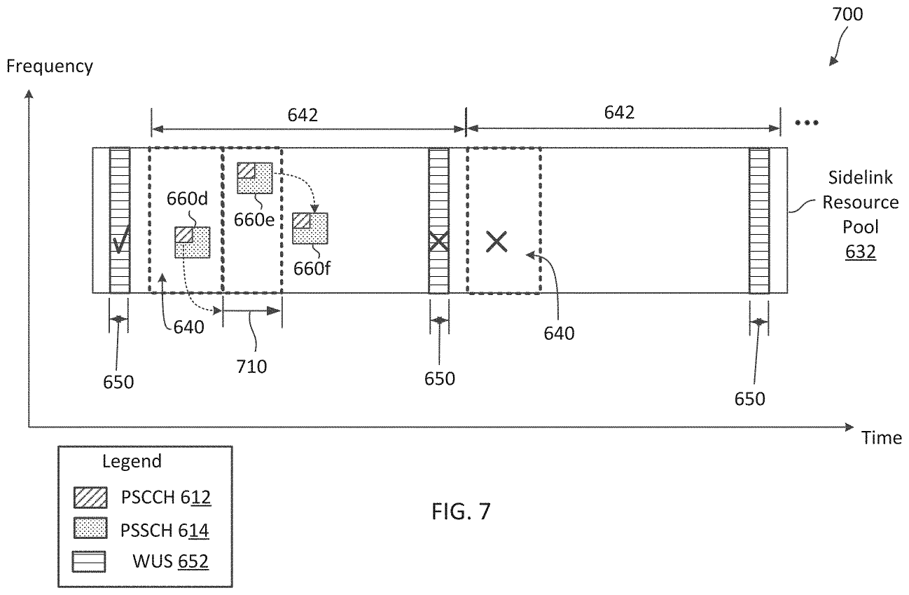

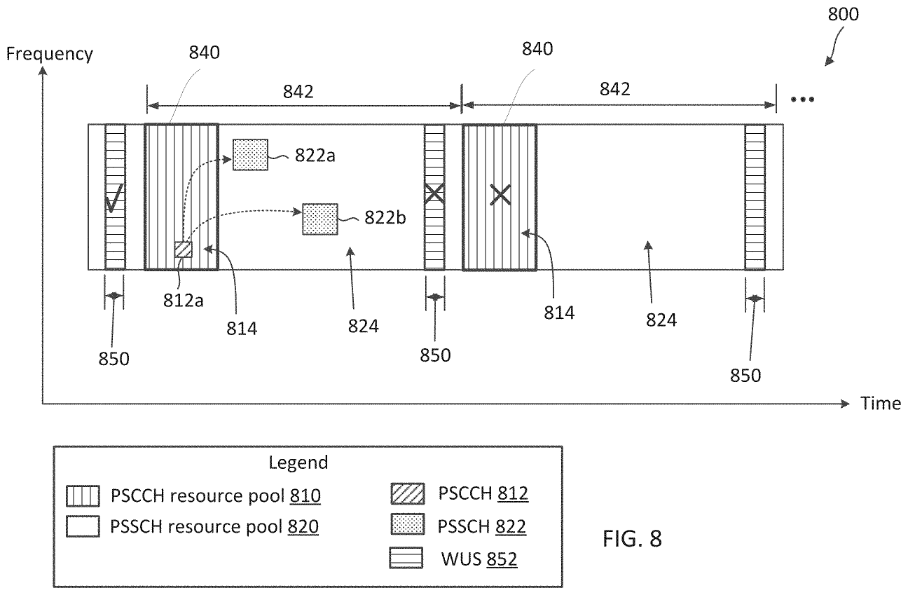

Accordingly, the present disclosure provides sidelink resource allocation techniques that can facilitate low-power communications over sidelink, for example, by reducing SCI monitoring durations at a remote UE. For example, a remote UE may be configured with a set of SCI monitoring resource regions (certain durations) that are spaced apart in time. The remote UE can monitor for SCI from a relay UE (over a forward link) only in the configured SCI monitoring resource regions instead of a continuous SCI monitoring whenever the remote UE is not in a transmission mode. In some aspects, the set of SCI monitoring resource regions may be part of a sidelink resource pool, where the sidelink resource pool may include sidelink resources, each including a PSCCH and a PSSCH as will be discussed more fully below with respect to FIGS. 6-7. In some other aspects, the set of SCI monitoring resource regions may be within a PSCCH resource pool separate from a PSSCH resource pool, and the relay UE 115 may transmit SCI using a PSCCH resource within a first SCI monitoring resource region of the set of SCI monitoring resource regions to indicate a PSSCH resource in the PSSCH resource pool as will be discussed more fully below with respect to FIG. 8. Additionally, WUS signaling techniques may be applied to allow a remote UE to further save power as will be discussed more fully below with respect to FIGS. 6-9.

FIG. 6 illustrates a sidelink communication scheme 600 for forward link operations according to some aspects of the present disclosure. The scheme 600 may be employed by UEs such as the UEs 115, 215 and/or 415, 420, 515, 520 in a network such as the networks 100 and/or 200 for sidelink communications. In particular, sidelink UEs may employ the scheme 600 for SCI monitoring and SCI/data communication over a sidelink in a forward direction, for example, from a relay sidelink UE to a remote sidelink UE. In some aspects, the scheme 600 can be employed in conjunction with the scheme 300. In FIG. 6, the x-axis represents time in some arbitrary units, and the y-axis represents frequency in some arbitrary units. In the scheme 600, In the scheme 600, a relay UE 615 within a coverage area 610 of a BS 605 and in communication with the BS 605 over a link 606 may operate as a relay for a remote UE 620. For instance, the relay UE 615 may relay UL communication (received over a reverse link 604) from the remote UE 620 to the BS 605 (over the link 606) and/or relay DL communication from the BS 605 (over the link 606) to the remote UE 620 (over a forward link 602). The BS 605 may be similar to the BSs 105, 205, 405, and/or 505. The relay UE 615 and/or the remote UEs 620 may be similar to the UEs 115 and/or 215. In some instances, the relay UE 615 may correspond to the relay UE 415c, and the remote UE 620 may correspond to the remote UE 420 in the scenario 400. In some instances, the relay UE 615 may correspond to the relay UE 515, and the remote UE 620 may correspond to the remote UE 520 in the scenario 500. The relay UE 615 may transmit a sidelink transmission to the remote UE 620 over a forward link 602, and the remote UE 620 may transmit a sidelink transmission to the relay UE 615 over a reverse link 604. Although FIG. 6 illustrates the relay UE 615 relaying for one remote UE 620, it should be understood that in other examples a relay UE may operate as a relay for a group of remote UEs 620 (e.g., about 2, 3, 4, 5 or more).

In the scheme 600, the relay UE 615 may communicate with the remote UE 620 using resources from a sidelink resource pool 632 as shown by 630. The sidelink resource pool 632 may be over a licensed band or a shared radio frequency band (e.g., in a shared spectrum or an unlicensed spectrum). The resource pool 632 may have the same sidelink slot resource structure (including 14 symbols) as in FIG. 3. For instance, the resource pool 632 may include a set of sidelink resources 660, for example, arranged in a number of slots across time and a number of subband in frequency similar to the sidelink resources 306 shown in FIG. 3. Each sidelink resource 660 may include a PSCCH 612 (e.g., the PSCCH 310) and a PSSCH 614 (e.g., PSSCH 320). For simplicity of illustration and discussion, FIG. 6 illustrates three sidelink resources 660 (shown as 660a, 660b, and 660c). In some aspects, the BS 605 may configure the relay UE 615 with the sidelink resource pool. In some other aspects, the relay UE 615 may be determined the sidelink resource pool based on a configuration received from the BS 605. In some aspects, the sidelink resource pool 632 may be used for transmissions from the relay UE 615 to the remote UE 620 over the forward link 602. In some aspects, the sidelink resource pool 632 be also be used for transmissions from the remote UE 620 to the relay UE 615 the reverse link 604.

To reduce the amount of SCI monitoring time at the remote UE 620, the relay UE 615 may determine a set of SCI monitoring resource regions 640 from the sidelink resource pool 632. The set of SCI monitoring resource regions 640 are spaced apart in time. For instance, the set of SCI monitoring resource regions 640 may be periodic, repeating at a time interval 642. The relay UE 615 may transmit, to the remote UE 620, a configuration indicating the set of SCI monitoring resource regions 640 where the remote UE 620 may monitor for SCI from the relay UE 615. The SCI candidates that the remote UE 620 monitors may not be all possible SCI candidates in the SCI monitoring resource regions 640 but remote UE 620 may monitor a subset of all possible SCI candidates. The SCI candidates for the UE 620 may be determined based on UE ID of UE 620. Accordingly, the relay UE 615 may monitor for SCI in the SCI monitoring resource regions 640. In this regard, the relay UE 615 may perform SCI decoding in PSCCH 612 of each resource 660 within a SCI monitoring resource region 640. For instance, the relay UE 615 may transmit SCI on PSCCH 612 in resource 660a within the monitoring resource region 640. Accordingly, the remote UE 620 may successfully decode the SCI from the PSCCH 612 in resource 660a. In some aspects, the relay UE 615 may include a destination ID indicating a UE ID of the remote UE 620, and thus the remote UE 620 may determine that the SCI is addressed to the remote UE based on the destination ID.

In some aspects, the SCI in the resource 660a may indicate or reference a PSSCH 614 within the SCI monitoring resource region 640 where the SCI is transmitted. For instance, the SCI may reference the PSSCH 614 of the resource 660a. In some aspects, the SCI may also include a MCS and/or a transport block size associated with the sidelink data in the PSSCH 614 of the resource 660a. Accordingly, the remote UE 620 may receive, demodulate, and decode data from the PSSCH 614 of the resource 660a according to the SCI.

In some aspects, the SCI in the resource 660a may indicate or reference a PSSCH 614 outside the SCI monitoring resource region 640 where the SCI is transmitted. For instance, the relay UE 615 may include in the SCI (transmitted in the PSCCH 612 in resource 660a) an indication or reference to a resource 660b outside of the SCI monitoring resource region 640 as shown by the dashed arrow from the resource 660a to the resource 660b. Similarly, the relay UE 615 may transmit SCI in the PSCCH 612 of the resource 660b to provide information, such as a MCS and/or a transport block size associated with the sidelink data in the PSSCH 614 of the resource 660b. Accordingly, the remote UE 620 may receive, demodulate, and decode data from the PSSCH 614 of the resource 660b according to the SCI. In some aspects, the relay UE 615 may also include in the SCI (transmitted in the PSCCH 612 in resource 660b) an indication or reference to a resource 660c as shown by the dashed arrow from the resource 660b to the resource 660c. Similarly, the relay UE 615 may also include in the SCI (transmitted in the PSCCH 612 in resource 660c) an indication or reference to another resource 660, and so on.

In some aspects, the relay UE 615 may select the resources 660a, 660b, and/or 660c based on SCI sensing results. For instance, the relay UE 615 may perform SCI sensing in the sidelink resource pool 632 to determine whether a resource 660 in the SCI monitoring resource region 640 is available or reserved by another sidelink UE. If a resource 660 (e.g., the resource 660) is available, the relay UE 615 may transmit in the resource 660. If, however, another sidelink UE has reserved a resource 660, the relay UE 615 may not transmit in the resource 660. Similarly, the relay UE 615 may perform SCI sensing in resource regions outside of the SCI monitoring resource regions 640 for selecting a resource 660 (e.g., the resources 660b and/or 660c) for transmissions to the remote UE 620.

In some aspects, the relay UE 615 and the remote UE 620 may utilize HARQ techniques for sidelink communications to improve reliability. For instance, after the remote UE 620 received sidelink data from the relay UE 615, the remote UE 620 may feedback an ACK to the relay UE 615 if the data is decoded successfully. Conversely, if the remote UE 620 fails to decode the data successfully, the remote UE 620 may transmit an NACK to the relay UE 615. If the relay UE 615 receives an NACK from the remote UE 620, the relay UE 615 may retransmit the data to the remote UE 620. When applying HARQ, the relay UE 615 may include HARQ related information (e.g., a HARQ process ID, NDI, and/or RV associated with the data) in corresponding SCI. In some aspects, the relay UE 615 may transmit utilize the PSSCH 614 of the resource 660a for an initial data transmission, and may utilize the PSSCH 614 of the resource 660b and/or 660c for a data retransmission in case an NACK is received from the remote UE 620.

In some aspects, to provide further power saving at the remote UE 620, the relay UE 615 may configure the remote UE 620 with WUS monitoring occasions 650. The WUS monitoring occasions 650 may allow the remote UE 115 to enter a sleep mode to save power (e.g., when there is no active communication between the relay UE 615 and the remote UE 620). The WUS monitoring occasions 650 may be used by the relay UE 615 to transmit a WUS 652 (e.g., a predetermined waveform sequence or SCI indicating a wake-up request) to wake up the remote UE 620 when the relay UE 615 has data for the remote UE 620. For instance, when the remote UE 620 operate in the sleep mode, the remote UE 620 may wake up to monitor for a WUS 652 during a WUS monitoring occasion 650. If the remote UE 620 detected a WUS 652, the remote UE 620 may monitor for transmissions from the relay UE 615. If, however, there is no WUS 652 detected, the remote UE 620 may return to operate in the sleep mode. In some instances, the remote UE 620 may be capable of operating in multiple sleep mode levels, for example, a deep-sleep mode or a light-sleep mode. For instance, a light-sleep mode may include powering down some components (e.g., RF components) at the remote UE 620, and a deep-sleep mode may include powering down more components (e.g., RF components and some based band processing components) at the remote UE 620. Hence, a deep-sleep mode may provide a greater amount of power saving than a light-sleep mode. In some aspects, the remote UE 620 may determine whether to enter a deep-sleep mode or a light-sleep mode upon determining no WUS is detected in a WUS monitoring occasion 650, for example, based on a length of the sleep time.

In some aspects, the WUS monitoring occasions 650 may be configured with respect to the SCI monitoring resource regions 640, for example, with one WUS monitoring occasion 650 prior to each SCI monitoring resource region 640. In this way, if the relay UE 615 has data for the remote UE 620, the relay UE 615 may transmit a WUS 652 during a WUS monitoring occasion 650 (shown by the checkmark) and proceed to transmit SCI for the remote UE 620 in a following SCI monitoring resource region 640. If the relay UE 615 has no data for the remote UE 620, the relay UE 615 may not transmit a WUS 652 during a WUS monitoring occasion 650 (shown by the symbol “X”). As such, the remote UE 620 may not detect the WUS signal 652 in the WUS monitoring occasion 650, and skip SCI monitoring in the following SCI monitoring resource region 640 (shown by the symbols “X”).

In some aspects, the remote UE 620 may wake up to receive the SCI in the resource 660a, 660b, and 660c, and may enter a sleep more after receiving data from the resource 660c if there is no more data for the remote UE 620. The remote UE 620 may remain in the sleep mode until a next WUS monitoring occasion 650, where the remote UE 620 may monitor for a WUS 652 in the next WUS monitoring occasion 650.

In some aspects, the relay UE 615 may configure a group of remote UEs similar to the remote UE 620 with the WUS monitoring occasions 650 and/or the SCI monitoring resource regions 640.

FIG. 7 illustrates a sidelink communication scheme 600 for forward link operations according to some aspects of the present disclosure. The scheme 700 may be employed by UEs such as the UEs 115, 215 and/or 415,420, 515, 520 in a network such as the networks 100 and/or 200 for sidelink communications. In particular, sidelink UEs may employ the scheme 600 for SCI monitoring and SCI/data communication over a sidelink in a forward direction, for example, from a relay sidelink UE to a remote sidelink UE. In FIG. 7, the x-axis represents time in some arbitrary units, and the y-axis represents frequency in some arbitrary units. The scheme 700 is similar to the scheme 600 in many respects, and may further illustrate mechanisms for extending a SCI monitoring resource region.

As shown, the relay UE 615 transmits SCI on PSCCH 612 in a resource 660d within a monitoring resource region 640. The relay UE 615 may determine to extend the monitoring region 640, for example, with an extended duration, by including an indication of the extended region 710 in the SCI. The SCI may be included a destination ID addressing specifically to the remote UE 620 or a group of remote UEs including the remote UE 620. In other aspects, the relay UE 615 may determine to extend the monitoring region 640, for example, with an extended region 710, by detection of SCI in monitoring region 640, where the detected SCI is for the UE 620 or a group of remote UEs including the remote UE 620. Subsequently, the relay UE 615 may transmit another SCI in a PSCCH 612 of a resource 660e within the extended region 710. Accordingly, the remote UE 620 may monitor/decode SCI in the SCI monitoring resource region and detect the SCI in the resource 660d. The remote UE 620 may be aware of the extended region 710 based on the SCI and continue to monitor for SCI in the extended region 710. The SCI candidates that the remote UE 620 monitors may not be all possible SCI candidates in the extended region 710 but remote UE 620 may monitor a subset of all possible SCI candidates. The SCI candidates for the UE 620 may be determined based on UE ID of UE 620.

The remote UE 620 may detect the SCI transmitted by the relay UE 615 in the PSCCH 612 of the resource 660e from the monitoring during the extended region 710. For instance, the relay UE 615 may further include, in the SCI (destined to the remote UE 620), an indication or a reference for a resource 660f outside of the extended region 710 as shown by the dotted arrow from the resource 660e to the resource 660f. The relay UE 615 may further transmit, to the remote UE 620, SCI in the PSCCH 612 of the resource 660f and data in the PSSCH 614 of the resource 660f. Accordingly, the remote UE 620 may detect and receive SCI from the PSCCH 612 of the resource 660f and receive data from the PSSCH 614 of the resource 660f according to the SCI.

In some aspects, the relay UE 615 and the remote UE 620 may also apply similar WUS signaling techniques to allow for power saving at the remote UE 620 as discussed above in relation to FIG. 6.

As can be observed from the scheme 700, the extension of the SCI monitoring resource region can provide the relay UE 615 with flexibility in extending the duration of an SCI monitoring resource region from an initial configuration as necessary, for example, based on traffic arrival time and/or traffic loading.

FIG. 8 illustrates a resource partitioning scheme 800 according to some aspects of the present disclosure. The scheme 800 may be employed by UEs such as the UEs 115, 215 and/or 415, 420, 515, 520 in a network such as the networks 100 and/or 200 for sidelink communications. In particular, sidelink UEs may employ the scheme 800 for SCI monitoring and SCI/data communication over a sidelink in a forward direction, for example, from a relay sidelink UE to a remote sidelink UE. In FIG. 8, the x-axis represents time in some arbitrary units, and the y-axis represents frequency in some arbitrary units.

In the scheme 800, a relay UE 615 may communicate with a remote UE 620 using separate PSCCH resource pool 810 and PSSCH resource pool 820. The PSCCH resource pool 810 and the PSSCH resource pool 820 may be over a licensed band or a shared radio frequency band (e.g., in a shared spectrum or an unlicensed spectrum). The PSCCH resource pool 810 may include a set of PSCCH resources 812 (e.g., time-frequency resources), which may be used for SCI transmission from the relay UE 615 to a remote UE 620. The PSCCH resource pool 810 may include a number of the PSCCH resources 812 across time and a number of PSCCH resources 812 across frequency. The PSSCH resource pool 820 may include a set of PSSCH resources 822, which may be used for data transmission from the relay UE 615 to a remote UE 620. Similarly, the PSSCH resource pool 820 may include a number of the PSSCH resources 822 across time and a number of PSSCH resources 822 across frequency. For simplicity of illustration and discussion, FIG. 8 illustrates one PSCCH resource 812a in the PSCCH resource pool 810 and two PSSCH resources 822 in the PSSCH resource pool 820. In some aspects, a BS 605 in communication with the relay UE 615 may configure the relay UE 615 with resources for sidelink communications and the relay UE 615 may determine the PSCCH resource pool 810 and the PSSCH resource pool 820 from the configured resources.

Similar to the scheme 600, in order to reduce the amount of SCI monitoring time at the remote UE 620, the relay UE 615 may configure the PSCCH resource pool 810 such that the PSCCH resource pool 810 may include PSCCH resource regions 814 that are spaced apart from each other in time. In some aspects, the PSCCH resource regions 814 may be referred to as monitoring resource regions. For instance, the set of PSCCH resource regions 814 may be periodic, repeating at a time interval 842. The PSCCH resource regions 814 may interleave with PSSCH resource regions 824 of the PSSCH resource pool 820. In this way, the relay UE 615 may transmit SCI in a PSCCH resource region 814 to indicate one or more PSSCH resources 822 in a following PSSCH resource region 824. In some aspects, the relay UE 615 may transmit, to the remote UE 620, a configuration indicating the set of PSCCH resource regions 814 where the remote UE 620 may monitor for SCI from the relay UE 615. Accordingly, the PSCCH resource regions 814 may also be referred to as SCI monitoring resource regions.

In the illustrated example, the relay UE 615 transmits SCI in a PSCCH resource 812a within a PSCCH resource region 814. The remote UE 620 may monitor for SCI in the monitoring resource region 814, and may receive SCI in the PSCCH resource 812a within the resource region 840. The SCI candidates that the remote UE 620 monitors may not be all possible SCI candidates in the monitoring resource region 814 but remote UE 620 may monitor a subset of all possible SCI candidates. The SCI candidates for the UE 620 may be determined based on UE ID of UE 620. In some aspects, the SCI in the PSCCH resource 812a may indicate one or more PSSCH resources 822 in a following PSSCH resource region 824. For example, the SCI may include an indication or a reference to a PSSCH resource 822a and 822b in the PSSCH resource pool 820 (outside of the PSCCH resource region 814). The remote UE 620 may monitor for SCI in the SCI monitoring resource regions 814. For instance, the remote UE 620 may decode each PSCCH resource 812 in the SCI monitoring resource regions 814 to determine whether there is any SCI for the remote UE 620. In some aspects, the remote UE 620 may be configured (e.g., by the relay UE 615) to monitor a subset of the PSCCH resources 812 (less than all the PSCCH resources 812) in the SCI monitoring resource regions 814. The remote UE 620 may detect the SCI in the PSCCH resource 812a and subsequently receive data from the PSSCH resources 822a and 822b indicated by the SCI.

In some aspects, the relay UE 615 may configure the remote UE 620 with WUS monitoring occasions 850 similar to the scheme 600. The WUS monitoring occasions 850 may be used by the relay UE 615 to transmit a WUS 852 (e.g., a predetermined waveform sequence or SCI indicating a wake-up request) to wake up the remote 620 when the relay UE 615 has data for the remote UE 620. The relay UE 615 may also configure the WUS monitoring occasions 850 may with respect to the SCI monitoring resource regions 814, for example, with one WUS monitoring occasion 650 prior to each SCI monitoring resource region 640. In this way, if the relay UE 615 has data for the remote UE 620, the relay UE 615 may transmit a WUS 852 during a WUS monitoring occasion 850 (shown by the checkmark) and proceed to transmit SCI for the remote UE 620 in a following SCI monitoring resource region 814. If the relay UE 615 has no data for the remote UE 620, the relay UE 615 may not transmit a WUS 852 during a WUS monitoring occasion 850 (shown by the symbol “X”). As such, the remote UE 620 may not detect the WUS 852 in the WUS monitoring occasion 850, and skip SCI monitoring in the following SCI monitoring resource region 814 (shown by the symbols “X”).

In some aspects, the remote UE 620 may wake up to receive the SCI in the PSCCH resource 812a, and data in the PSSCH resources 822a and 822b, and may enter a sleep more after receiving data from the resource 822b if there is no more data for the remote UE 620. The remote UE 620 may remain in the sleep mode until a next WUS monitoring occasion 850. In some aspects, the remote UE 620 may be capable of operating in multiple sleep mode levels, for example, a deep-sleep mode or a light-sleep mode, and may determine whether to enter a deep-sleep mode or a light-sleep mode until the next WUS monitoring occasion 850.

In some aspects, the relay UE 615 may configure a group of remote UEs similar to the remote UE 620 with the WUS monitoring occasions 850, the PSCCH resource pool, and/or the PSSCH resource pool 820.

Although FIGS. 6-8 are described in the context of a relay UE 615 determining sidelink resources, SCI resource monitoring regions, and/or separate PSCCH resource pool and PSSCH resource pool, it should be understood that in other examples a BS 605 may configure the UE 615 and/or the remote UE 620 with similar resource monitoring information.

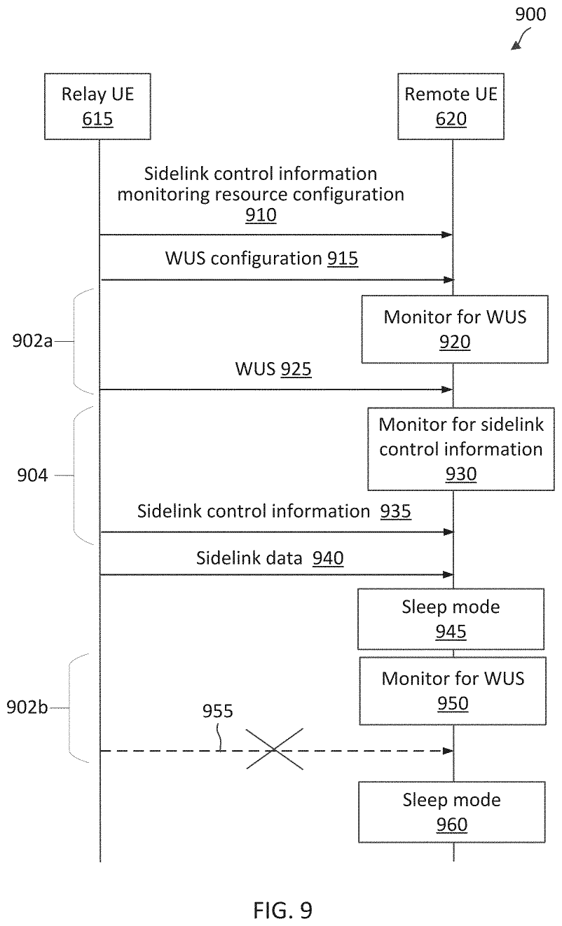

FIG. 9 is a sequence diagram illustrating a sidelink communication method 900 according to some aspects of the present disclosure. The method 900 may be implemented between the relay UE 615 and the remote UE 620. The method 900 may employ similar mechanisms as discussed above with respect to FIGS. 4-8 for communications. Although the method 900 illustrates the relay UE 615 in communication with one remote UE 620, it should be understood that in other examples the relay UE 615 may communicate with any suitable number of remote UEs 620 (e.g., about 2, 3, 4, 5, 6 or more) over a sidelink. As illustrated, the method 900 includes a number of enumerated actions, but embodiments of the method 900 may include additional actions before, after, and in between the enumerated actions. In some embodiments, one or more of the enumerated actions may be omitted or performed in a different order.

At action 910, the relay UE 615 transmits a configuration indicating a set of SCI monitoring resource regions (e.g., the resource regions 640 and/or 814) to the remote UE 620. The set of SCI monitoring resource regions are spaced apart from each other in time. In some aspects, the set of SCI monitoring resource regions may be periodic. Accordingly, the remote UE 620 may receive the SCI monitoring configuration.

At action 915, the relay UE 615 transmits a WUS configuration to the remote UE 620. The WUS configuration may indicate WUS monitoring occasions 902a and 902b (e.g., the WUS monitoring occasions 650 and 850) where the relay UE 615 may transmit a WUS (e.g., the WUS 652 and/or 852). Accordingly, the remote UE 620 may receive the WUS configuration. Each WUS monitoring occasion may be associated with a SCI monitoring resource region as discussed above in relation to FIGS. 6 and 8. In some aspects, the remote UE 620 may enter a sleep mode when the remote UE 620 has no active communications with the relay UE 615.

At action 920, the remote UE 620 may wake up to monitor for a WUS from the relay UE 615 during a WUS monitoring occasion.

For instance, at action 925, during the WUS monitoring occasion 902a, the relay UE 615 may transmit a WUS associated with (e.g., prior to) one of the SCI monitoring resource region, to the remote UE 620. The remote UE 620 may monitor for the WUS in the WUS monitoring occasion 902a. Accordingly, the remote UE 620 may detect the WUS.

At action 930, in response to detecting the WUS in the WUS monitoring occasion 902a, the remote UE 620 may monitor for SCI within the associated SCI monitoring resource region.

At action 935, the relay UE 615 transmits SCI to the UE 620 within the SCI monitoring resource region associated with the WUS monitoring occasion 902a. In some aspects, the UE 620 may transmit, to the UE 620, the SCI in a PSCCH resource within the SCI resource region.

In some aspects, the set of SCI monitoring resource regions may be part of a sidelink resource pool including PSCCH resources and PSSCH resources as discussed above in relation to FIGS. 6 and 7, and the SCI may indicate a PSCCH resource within the SCI monitoring resource region. Additionally or alternatively, the SCI may indicate a PSSCH resource outside of the SCI monitoring resource region.

In some aspects, the set of SCI monitoring resource regions are within a PSSCH resource pool, for example, as discussed above in relation to FIG. 8, and the SCI may indicate a PSSCH resource for the sidelink data, where the PSSCH resource may be in a PSSCH resource pool different than the PSCCH resource pool.

At action 940, the relay UE 615 transmits sidelink data to the remote UE 620 in the PSSCH resource(s) indicated by the SCI. The SCI may include information for the UE 620 to receive data in the indicated PSSCH resource(s). For example, the SCI may include a destination ID indicating a UE ID of the remote UE 620. The SCI may also include information for the remote UE 620 to demodulate and/or decode data in the indicated PSSCH resource(s). For example, the SCI may include a data format associated with the data in the indicated PSSCH resource(s), where the data format may include a MCS used for encoding the data, a transport block size of the data, and/or HARQ related information (e.g., a HARQ process ID, NDI, and/or RV).

At action 945, after completing reception of the sidelink data, the remote UE 620 may enter a sleep mode until a next WUS monitoring occasion 902b.

At action 950, the remote UE 620 may wake up to monitor for a WUS from the relay UE 615 during the WUS monitoring occasion 902b. The relay UE 615 may determine that there is no data for the remote UE 620, and thus the relay UE 615 may not transmit a WUS to the remote UE 620 during the WUS monitoring occasion 902b as shown by the dashed arrow 955 with the symbol “X”. Accordingly, at action 960, the remote UE 620 enters the sleep mode again.

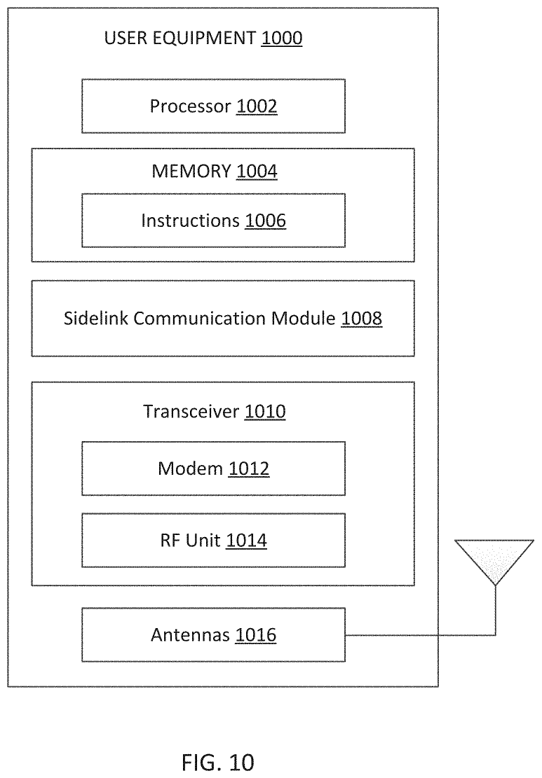

FIG. 10 is a block diagram of an exemplary UE 1000 according to some aspects of the present disclosure. The UE 1000 may be a UE 115 as discussed above with respect to FIG. 1, a UE 215 as discussed above with respect to FIG. 2, a UE 415 or 420 as discussed above with respect to FIG. 4, a UE 515 or 520 as discussed above with respect to FIG. 5, or a UE 615 or 620 as discussed above with respect to FIG. 6. As shown, the UE 1000 may include a processor 1002, a memory 1004, a sidelink communication module 1008, a transceiver 1010 including a modem subsystem 1012 and a radio frequency (RF) unit 1014, and one or more antennas 1016. These elements may be in direct or indirect communication with each other, for example via one or more buses.

The UE 1000 may be stationary or mobile. The UE 1000 may also be referred to as a mobile station, a terminal, an AT, a subscriber unit, a station, a customer premises equipment (CPE), a cellular phone, a smart phone, a PDA, a wireless modem, a wireless communication device, a handheld device, a laptop computer, a cordless phone, a WLL station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, an industrial manufacturing equipment, a global positioning system device, or any other suitable device that is configured to communicate via a wireless or wired medium. In some aspects, the UE 1000 may be considered machine-type communication (MTC) devices or evolved MTC (eMTC) devices. The MTC and the eMTC UEs may include, for example, robots, drones, remote devices, sensors, meters, monitors, location tags, etc., that may communicate with a BS (e.g., BS 1100), another device (e.g., remote device), or some other entity. A wireless node may provide, for example, connectivity for or to a network (e.g., a wide area network such as Internet or a cellular network) via a wired or wireless communication link. The UE 1000 be considered an Internet-of-Things (IoT) device, which may include a narrowband IoT (NB-IoT) device.

The processor 1002 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 1002 may also be implemented as a combination of computing devices, e.g., a combination of a DSP and a microprocessor, a plurality of microprocessors, one or more microprocessors in conjunction with a DSP core, or any other such configuration.

The memory 1004 may include a cache memory (e.g., a cache memory of the processor 1002), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an aspect, the memory 1004 includes a non-transitory computer-readable medium. The memory 1004 may store, or have recorded thereon, instructions 1006. The instructions 1006 may include instructions that, when executed by the processor 1002, cause the processor 1002 to perform the operations described herein with reference to the UEs 115 in connection with aspects of the present disclosure, for example, aspects of FIGS. 2-9. Instructions 1006 may also be referred to as program code, which may be interpreted broadly to include any type of computer-readable statement(s).

The sidelink communication 1008 may be implemented via hardware, software, or combinations thereof. For example, the sidelink communication module 1008 may be implemented as a processor, circuit, and/or instructions 1006 stored in the memory 1004 and executed by the processor 1002. In some examples, the sidelink communication module 1008 can be integrated within the modem subsystem 1012. For example, the sidelink communication module 1008 can be implemented by a combination of software components (e.g., executed by a DSP or a general processor) and hardware components (e.g., logic gates and circuitry) within the modem subsystem 1012.

The sidelink communication module 1008 may communicate with various components of the UE 1000 to perform aspects of the present disclosure, for example, aspects of FIGS. 2-9. In some aspects, the UE 1000 is a sidelink UE that initiates transmit/receive data in half-duplex mode. In some aspects, the sidelink communication module 1008 is configured to transmit, to a second UE (e.g., a remote UE similar to the UE 115, 215, 420 or 520) over a sidelink, a configuration indicating a set of SCI monitoring resource regions. The sidelink communication module 1008 is further configured to transmit, to the second UE SCI in a first SCI monitoring resource region of the set of SCI monitoring resource regions. Further, the sidelink communication module 1008 is configured to transmit, to the second UE, in a resource indicated by the SCI.

In some instances, the sidelink communication module 1008 is configured to transmit to the second UE, SCI in a PSCCH resource within the first SCI monitoring resource. In some examples, the SCI may indicate a first PSSCH resource within the first SCI monitoring resource region. In some other examples, the SCI may indicate a second PSSCH resource outside the first SCI monitoring resource region. In some aspects, the set of SCI monitoring resource regions may be part of a sidelink resource pool including PSCCH resources and PSSCH resources as discussed above in relation to FIGS. 6 and 7. In some aspects, the set of SCI monitoring resource regions are within a PSSCH resource pool, for example, as discussed above in relation to FIG. 8, and the SCI may indicate a PSSCH resource for the sidelink data, where the PSSCH resource may be in a PSSCH resource pool different than the PSCCH resource pool.

In some aspects, the sidelink communication module 1008 is configured to configure the second UE with WUS monitoring occasions with respect to the set of SCI monitoring resource regions. The sidelink communication module 1008 is configured to configure transmit a WUS in a WUS monitoring occasion if the UE 1000 has data for the second UE and transmit SCI in a following SCI monitoring resource region. The sidelink communication module 1008 is configured to configure refrain from transmitting a WUS in a WUS monitoring occasion if the UE 1000 has no data for the second UE.

In some aspects, the UE 1000 is a remote sidelink UE similar to the remote UE 420 of FIG. 4, the remote UE 520 of FIG. 5, or the remote UE 620 of FIG. 6. For example, the sidelink communication module 1008 is configured to receive, from a second UE (e.g., a relay UE similar to the UE 115, 215, 415 or 615) over a sidelink, a configuration indicating a set of SCI monitoring resource regions. The sidelink communication module 1008 is further configured to monitor for SCI from the second UE in a first SCI monitoring resource region of the set of SCI monitoring resource regions. Further, the sidelink communication module 1008 is configured to detect SCI from the second UE based on the monitoring and receive, from the second UE, in a resource indicated by the SCI.

In some instances, the sidelink communication module 1008 is configured to receive, from the second UE, SCI in a PSCCH resource within the first SCI monitoring resource. In some examples, the SCI may indicate a first PSSCH resource within the first SCI monitoring resource region. In some other examples, the SCI may indicate a second PSSCH resource outside the first SCI monitoring resource region. In some aspects, the set of SCI monitoring resource regions may be part of a sidelink resource pool including PSCCH resources and PSSCH resources as discussed above in relation to FIGS. 6 and 7. In some aspects, the set of SCI monitoring resource regions are within a PSSCH resource pool, for example, as discussed above in relation to FIG. 8, and the SCI may indicate a PSSCH resource for the sidelink data, where the PSSCH resource may be in a PSSCH resource pool different than the PSCCH resource pool.

In some aspects, the sidelink communication module 1008 is configured to receive a configuration for WUS monitoring occasions from the second UE, where the WUS monitoring occasions are configured with respect to the set of SCI monitoring resource regions. The sidelink communication module 1008 is configured to configure monitor for a WUS in a WUS monitoring occasion. The sidelink communication module 1008 is configured to wake up to monitor for SCI in a following SCI monitoring resource region if a WUS is detected from the monitoring. Alternatively, the sidelink communication module 1008 is configured to sleep until a next WUS monitoring occasion if there is no WUS detected from the monitoring.

As shown, the transceiver 1010 may include the modem subsystem 1012 and the RF unit 1014. The transceiver 1010 can be configured to communicate bi-directionally with other devices, such as the BSs 105. The modem subsystem 1012 may be configured to modulate and/or encode the data from the memory 1004 and/or the beam module 1008 according to a modulation and coding scheme (MCS), e.g., a low-density parity check (LDPC) coding scheme, a turbo coding scheme, a convolutional coding scheme, a digital beamforming scheme, etc. The RF unit 1014 may be configured to process (e.g., perform analog to digital conversion or digital to analog conversion, etc.) modulated/encoded data (e.g., PSCCH, PSSCH, SCI-1, SCI-2, PSCCH monitoring resource region configuration, PSSCH resource pool configuration, PSCCH resource pool configuration, WUS, WUS monitoring occasion configurations) from the modem subsystem 1012 (on outbound transmissions) or of transmissions originating from another source such as a UE 115 or a BS 105. The RF unit 1014 may be further configured to perform analog beamforming in conjunction with the digital beamforming. Although shown as integrated together in transceiver 1010, the modem subsystem 1012 and the RF unit 1014 may be separate devices that are coupled together at the UE 115 to enable the UE 115 to communicate with other devices.

The RF unit 1014 may provide the modulated and/or processed data, e.g. data packets (or, more generally, data messages that may include one or more data packets and other information), to the antennas 1016 for transmission to one or more other devices. The antennas 1016 may further receive data messages transmitted from other devices. The antennas 1016 may provide the received data messages for processing and/or demodulation at the transceiver 1010. The transceiver 1010 may provide the demodulated and decoded data (e.g., PSCCH, PSSCH, SCI-1, SCI-2, PSCCH monitoring resource region configuration, PSSCH resource pool configuration, PSCCH resource pool configuration, WUS, WUS monitoring occasion configurations, RRC configuration, sidelink resource pool allocation) to the beam module 1008 for processing. The antennas 1016 may include multiple antennas of similar or different designs in order to sustain multiple transmission links. The RF unit 1014 may configure the antennas 1016.

In an aspect, the UE 1000 can include multiple transceivers 1010 implementing different RATs (e.g., NR and LTE). In an aspect, the UE 1000 can include a single transceiver 1010 implementing multiple RATs (e.g., NR and LTE). In an aspect, the transceiver 1010 can include various components, where different combinations of components can implement different RATs.

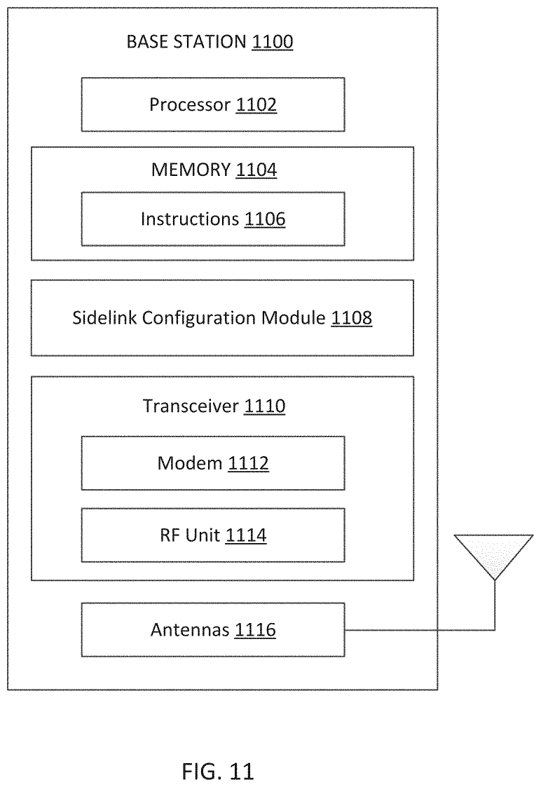

FIG. 11 is a block diagram of an exemplary BS 1100 according to some aspects of the present disclosure. The BS 1100 may be a BS 105 in the network 100 as discussed above in FIG. 1, a BS 205 as discussed above in FIG. 2, a BS 405 as discussed above in FIG. 4, a BS 505 as discussed above in FIG. 5, or a BS 605 as discussed above in FIG. 6. As shown, the BS 1100 may include a processor 1102, a memory 1104, an sidelink configuration module 1108, a transceiver 1110 including a modem subsystem 1112 and a RF unit 1114, and one or more antennas 1116. These elements may be in direct or indirect communication with each other, for example via one or more buses.

The processor 1102 may have various features as a specific-type processor. For example, these may include a CPU, a DSP, an ASIC, a controller, a FPGA device, another hardware device, a firmware device, or any combination thereof configured to perform the operations described herein. The processor 1102 may also be implemented as a combination of computing devices, e.g., a combination of a DSP and a microprocessor, a plurality of microprocessors, one or more microprocessors in conjunction with a DSP core, or any other such configuration.

The memory 1104 may include a cache memory (e.g., a cache memory of the processor 1102), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some aspects, the memory 1104 may include a non-transitory computer-readable medium. The memory 1104 may store instructions 1106. The instructions 1106 may include instructions that, when executed by the processor 1102, cause the processor 1102 to perform operations described herein, for example, aspects of FIGS. 2-9. Instructions 1106 may also be referred to as program code. The program code may be for causing a wireless communication device to perform these operations, for example by causing one or more processors (such as processor 1102) to control or command the wireless communication device to do so. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The sidelink configuration module 1108 may be implemented via hardware, software, or combinations thereof. For example, the sidelink configuration module 1108 may be implemented as a processor, circuit, and/or instructions 1106 stored in the memory 1104 and executed by the processor 1102. In some examples, the sidelink configuration module 1108 can be integrated within the modem subsystem 1112. For example, the sidelink configuration module 1108 can be implemented by a combination of software components (e.g., executed by a DSP or a general processor) and hardware components (e.g., logic gates and circuitry) within the modem subsystem 1112.

The sidelink configuration module 1108 may communicate with various components of the BS 1100 to perform various aspects of the present disclosure, for example, aspects of FIGS. 2-9. The sidelink configuration module 1108 is configured to configure UEs (e.g., the UEs 115, 215, 415 and/or 515) with sidelink resource pools for sidelink communications. In some aspects, the sidelink configuration module 1108 may configure the UEs with a resource pool for sidelink communications, for example, as discussed above in relation to FIG. 6-8.

As shown, the transceiver 1110 may include the modem subsystem 1112 and the RF unit 1114. The transceiver 1110 can be configured to communicate bi-directionally with other devices, such as the UEs 115 and/or another core network element. The modem subsystem 1112 may be configured to modulate and/or encode data according to a MCS, e.g., a LDPC coding scheme, a turbo coding scheme, a convolutional coding scheme, a digital beamforming scheme, etc. The RF unit 1114 may be configured to process (e.g., perform analog to digital conversion or digital to analog conversion, etc.) modulated/encoded data (e.g., RRC configuration, sidelink resource pools configurations) from the modem subsystem 1112 (on outbound transmissions) or of transmissions originating from another source such as a UE 115. The RF unit 1114 may be further configured to perform analog beamforming in conjunction with the digital beamforming. Although shown as integrated together in transceiver 1110, the modem subsystem 1112 and/or the RF unit 1114 may be separate devices that are coupled together at the BS 105 to enable the BS 105 to communicate with other devices.

The RF unit 1114 may provide the modulated and/or processed data, e.g. data packets (or, more generally, data messages that may contain one or more data packets and other information), to the antennas 1116 for transmission to one or more other devices. This may include, for example, transmission of information to complete attachment to a network and communication with a camped UE 115 according to some aspects of the present disclosure. The antennas 1116 may further receive data messages transmitted from other devices and provide the received data messages for processing and/or demodulation at the transceiver 1110. The transceiver 1110 may provide the demodulated and decoded data to the sidelink configuration module 1108 for processing. The antennas 1116 may include multiple antennas of similar or different designs in order to sustain multiple transmission links.

In an aspect, the BS 1100 can include multiple transceivers 1110 implementing different RATs (e.g., NR and LTE). In an aspect, the BS 1100 can include a single transceiver 1110 implementing multiple RATs (e.g., NR and LTE). In an aspect, the transceiver 1110 can include various components, where different combinations of components can implement different RATs.

various components, where different combinations of components can implement different RATs.

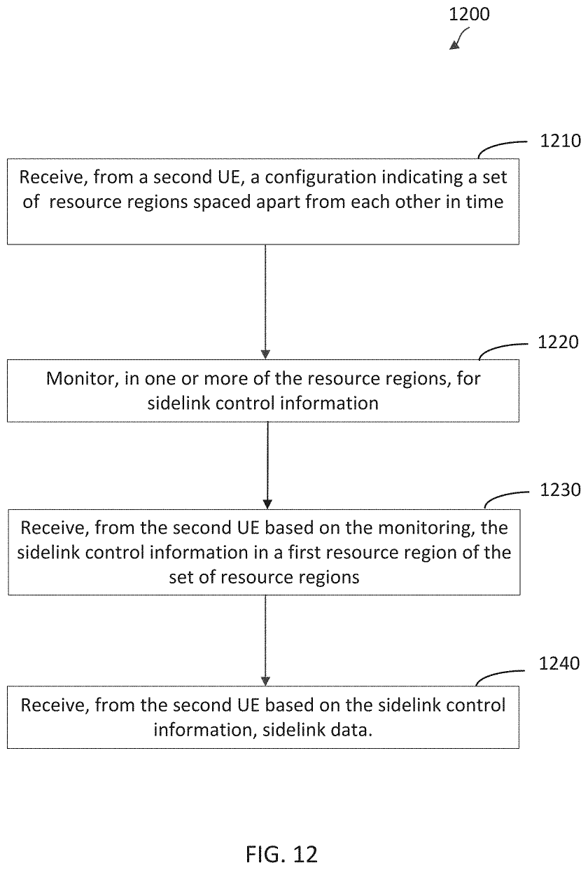

FIG. 12 is a flow diagram of a sidelink communication process 1200 according to some aspects of the present disclosure. Aspects of the process 1200 can be executed by a computing device (e.g., a processor, processing circuit, and/or other suitable component) of a wireless communication device or other suitable means for performing the steps. For example, a wireless communication device, such as the UEs 115, 215, 420, and/or 520, may utilize one or more components, such as the processor 1002, the memory 1004, the sidelink communication module 1008, the transceiver 1010, the modem 1012, and the one or more antennas 1016, to execute the steps of process 1200. The process 1200 may employ, at least in part, similar mechanisms as discussed above with respect to FIGS. 6-10. As illustrated, the process 1200 includes a number of enumerated steps, but aspects of the process 1200 may include additional steps before, after, and in between the enumerated steps. In some aspects, one or more of the enumerated steps may be omitted or performed in a different order.

At block 1210, a first UE may receive, from a second UE, a configuration indicating a set of SCI monitoring resource regions spaced apart from each other in time. The first UE may be a remote UE similar to the remote UEs 420, 520, and 620, and the second UE may be a relay UE similar to the relay UEs 415, 515, and 615. In some instances the set of control information resource region may be similar to the SCI monitoring resource region 640 of FIG. 6, the extended SCI monitoring resource region of FIG. 7, and/or the SCI monitoring resource region of FIG. 8. In some instances, the first UE may utilize one or more components, such as the processor 1002, the sidelink communication module 1008, the transceiver 1010, the modem 1012, and the one or more antennas 1016, to perform the operations at block 1210.

At block 1220, the first UE may monitor, in one or more SCI monitoring resource regions of the set of SCI monitoring resource regions, for SCI (SCI). In some instances, the SCI may include information for the first UE to decode data (e.g., PSSCH data) associated with the SCI. In some aspects, the SCI monitoring resource regions are associated with a monitoring periodicity. In some instances, the first UE may utilize one or more components, such as the processor 1002, the sidelink communication module 1008, the transceiver 1010, the modem 1012, and the one or more antennas 1016, to perform the operations at block 1220.

At block 1230, the first UE may receive, from the second UE based on the monitoring, the SCI in a first SCI monitoring resource region of the set of SCI monitoring resource regions. In some aspects, the SCI may be received in a PSCCH resource within the first SCI monitoring resource region. In some aspects, the SCI may indicate a PSSCH resource within the first SCI monitoring region. In some other aspects, the SCI may indicate a PSSCH resource outside the first SCI monitoring resource region. In some aspects, the SCI may indicate a PSSCH resource within the first SCI monitoring region and a second PSSCH resource outside the first SCI monitoring resource region. In some instances, the first UE may utilize one or more components, such as the processor 1002, the sidelink communication module 1008, the transceiver 1010, the modem 1012, and the one or more antennas 1016, to perform the operations at block 1230.

At block 1240, the first UE may receive, from the second UE based on the SCI, sidelink data. In some instances, the first UE may receive data, from the second UE over PSSCH. In some instances, the first UE may utilize one or more components, such as the processor 1002, the sidelink communication module 1008, the transceiver 1010, the modem 1012, and the one or more antennas 1016, to perform the operations at block 1240.

In some aspects, the SCI received at block 1230 may further indicate an extended region for the first SCI monitoring resource region, and the first UE may further monitor for another SCI during the extended region. In some aspects, the first UE may monitor for a wake up signal (WUS), and the monitoring the first SCI resource region at block 1220 is based on whether the WUS is detected or not. In some aspects, the first UE may monitor for a WUS associated with a second SCI monitoring resource region of the set of SCI monitoring resource region, and may refrain from monitoring the second SCI monitoring resource region if the WUS is not detected. However, if the first UE detected the WUS from the monitoring, the first UE may proceed monitor for SCI in the second SCI monitoring resource region. In some instances, if the first UE does not detect any SCI in a second SCI monitoring resource region, the first UE may determine to operate in a sleep mode until at least one of a next WUS monitoring occasion or a next SCI monitoring resource region of the set of SCI monitoring resource regions.

In some aspects, the set of SCI monitoring resource regions indicated by the configuration received at block 1210 may be within a PSCCH resource pool. The SCI received at block 1230 may indicate a PSSCH resource for the SCI data received at block 1240, where the PSSCH resource may be within a PSSCH resource pool different from the PSCCH resource pool. In some aspects, the set of SCI information monitoring resource regions indicated by the configuration received at block 1210 may include a subset of resources less than all resources in the PSCCH resource pool.

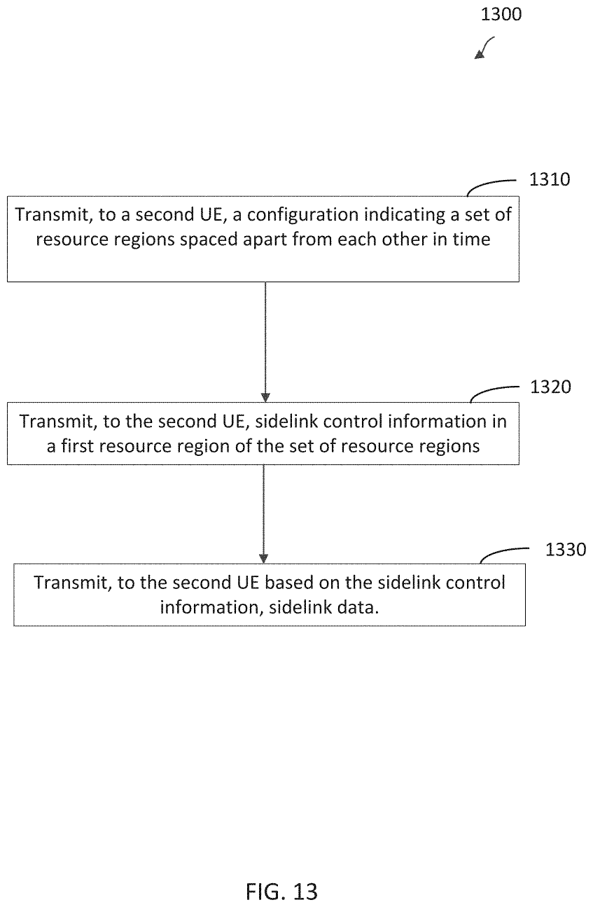

FIG. 13 is a flow diagram of a sidelink system information broadcasting process 1300 according to some aspects of the present disclosure. Aspects of the process 1300 can be executed by a computing device (e.g., a processor, processing circuit, and/or other suitable component) of a wireless communication device or other suitable means for performing the steps. For example, a wireless communication device, such as the UEs 115, 215, 415, and/or 515, may utilize one or more components, such as the processor 1002, the memory 1004, the sidelink communication module 1008, the transceiver 1010, the modem 1012, and the one or more antennas 1016, to execute the steps of process 1300. The process 1300 may employ, at least in part, similar mechanisms as discussed above with respect to FIGS. 6-10. As illustrated, the process 1300 includes a number of enumerated steps, but aspects of the process 1300 may include additional steps before, after, and in between the enumerated steps. In some aspects, one or more of the enumerated steps may be omitted or performed in a different order.

At block 1310, a first UE may transmit, to a second UE, a configuration indicating a set of SCI monitoring resource regions spaced apart from each other in time. The first UE may be a relay UE similar to the relay UEs 415, 515, and 615, and the second UE may be a remote UE similar to the remote UEs 420, 520, and 620. In some instances the set of control information resource region may be similar to the SCI monitoring resource region 640 of FIG. 6, the extended SCI monitoring resource region of FIG. 7, and/or the SCI monitoring resource region of FIG. 8. In some instances, the first UE may utilize one or more components, such as the processor 1002, the sidelink communication module 1008, the transceiver 1010, the modem 1012, and the one or more antennas 1016, to perform the operations at block 1310.

At block 1320, the first UE may transmit, to the second UE, the SCI in a first SCI monitoring resource region of the set of SCI monitoring resource regions. In some aspects, the SCI may be transmitted in a PSCCH resource within the first SCI monitoring resource region. In some aspects, the SCI may indicate a PSSCH resource within the first SCI monitoring region. In some other aspects, the SCI may indicate a PSSCH resource outside the first SCI monitoring resource region. In some aspects, the SCI may indicate transmitting the sidelink data in the first or the second PSSCH resource. In some instances, the first UE may utilize one or more components, such as the processor 1002, the sidelink communication module 1008, the transceiver 1010, the modem 1012, and the one or more antennas 1016, to perform the operations at block 1320.

At block 1330, the first UE may transmit, to the second UE based on the SCI, sidelink data. In some instances, the first UE may transmit data, to the second UE over a PSSCH. In some instances, the first UE may utilize one or more components, such as the processor 1002, the sidelink communication module 1008, the transceiver 1010, the modem 1012, and the one or more antennas 1016, to perform the operations at block 1330.

In some aspects, the SCI transmitted at block 1320 may further indicate an extended region for the first SCI monitoring resource region, and the first UE may further transmit another SCI during the extended region. In some aspects, the first UE may determine to transmit the SCI to the second UE in the first SCI monitoring resource region at block 1320, and may transmit to the second UE based on the determining, a wake up signal (WUS) in a WUS monitoring occasion associated with the first SCI monitoring resource region. In some aspects, the first UE may transmit, to the second UE, a WUS configuration indicating the WUS monitoring occasion. In some aspects, the first UE may further determine not to transmit any SCI in a second SCI monitoring resource region of the set of SCI monitoring resource regions, and refrain from transmitting a wakeup signal (WUS) in a WUS monitoring occasion associated with the second SCI monitoring resource region based on the determining.

In some aspects, the set of SCI monitoring resource regions indicated by the configuration transmitted at block 1310 may be within a PSCCH resource pool. The SCI transmitted at block 1320 may indicate a PSSCH resource for the SCI data transmitted at block 1330, where the PSSCH resource may be within a PSSCH resource pool different from the PSCCH resource pool. In some aspects, the set of SCI information monitoring resource regions indicated by the configuration transmitted at block 1310 include a subset of resources less than all resources in the PSCCH resource pool.

The present disclosure also includes the following aspects:

Aspect 1. A method of wireless communication performed by a first user equipment (UE), the method comprising: receiving, from a second UE, a configuration indicating a set of resource regions spaced apart from each other in time; monitoring, in one or more of the set of the resource regions, for sidelink control information; receiving, from the second UE based on the monitoring, the sidelink control information in a first resource region of the set of the resource regions; and receiving, from the second UE based on the sidelink control information, sidelink data.

Aspect 2. The method of aspect 1,wherein the set of the resource regions is associated with a monitoring periodicity.

Aspect 3. The method of any of aspects 1-2, wherein the receiving the sidelink control information comprises: receiving, from the second UE in a physical sidelink control channel (PSCCH) resource within the first resource region, the sidelink control information, wherein the sidelink control information indicates at least one of: a first physical sidelink shared channel (PSSCH) resource within the first resource region; or a second PSSCH resource outside the first resource region.

Aspect 4. The method of aspect 3, wherein: the sidelink control information indicates the first PSSCH resource; and the receiving the sidelink data comprises: receiving the sidelink data in the first PSSCH resource.

Aspect 5. The method of aspect 3, wherein: the sidelink control information indicates the second PSSCH resource; and the receiving the sidelink data comprises: receiving the sidelink data in the second PSSCH resource.

Aspect 6. The method of any of aspects 1-5, wherein: the sidelink control information further comprises an indication of an extended region for the first resource region; and the method further comprises: monitoring, during the extended region of the first resource region, for another sidelink control information.

Aspect 7. The method of any of aspects 1-6, further comprising: monitoring for a wakeup signal (WUS), wherein the monitoring the first resource region is based on the WUS being detected via the monitoring.

Aspect 8. The method of aspect 7, wherein the WUS is over a WUS monitoring occasion associated with the first resource region.

Aspect 9. The method of aspect 8, further comprising: receiving, from the second UE, a WUS configuration associated with the WUS monitoring occasion, wherein the monitoring for the WUS is based on the WUS configuration.

Aspect 10. The method of any of aspects 1-6, further comprising: monitoring for a wakeup signal (WUS) associated with a second resource region of the set of the resource regions; and refraining from monitoring the second resource region if no WUS is detected based on the WUS monitoring.

Aspect 11. The method of any of aspects 1-6, further comprising: determining, from the monitoring, that there is no sidelink control information detected in a second resource region of the set of the resource regions; and configuring, based on the determining, the first UE to operate in a sleep mode until one or more occurrences of a next wakeup signal (WUS) monitoring occasion and a next resource region of the set of the resource regions.

Aspect 12. The method of any of aspects 1-11, wherein the set of the resource regions are within a physical sidelink control channel (PSCCH) resource pool, and wherein the sidelink control information indicates a physical control shared channel (PSSCH) resource for the sidelink data, the PSSCH resource being within a PSSCH resource pool different from the PSCCH resource pool.

Aspect 13. The method of aspect 12, wherein the set of the resource regions comprises a subset of resources less than all resources in the PSCCH resource pool.

Aspect 14. The method of aspect 12, wherein the receiving the sidelink control information comprises: receiving the sidelink control information indicating a data format for the sidelink data.

Aspect 15. A method of wireless communication performed by a first user equipment (UE), the method comprising: transmitting, to a second UE, a configuration indicating a set of resource regions spaced apart from each other in time; transmitting, to the second UE, sidelink control information in a first resource region of the set of the resource regions; and transmitting, to the second UE based on the sidelink control information, sidelink data.

Aspect 16. The method of aspect 15, wherein the set of the resource regions is associated with a monitoring periodicity.

Aspect 17. The method of aspects 15 or 16, wherein the transmitting the sidelink control information comprises: transmitting, to the second UE in a physical sidelink control channel (PSCCH) resource within the first resource region, wherein the sidelink control information indicates at least one of: a first physical sidelink shared channel (PSSCH) resource within the first resource region; or a second PSSCH resource outside the first resource region.

Aspect 18. The method of aspect 17, wherein: the sidelink control information indicates the first PSSCH resource; and the transmitting the sidelink data comprises: transmitting the sidelink data in the first PSSCH resource.

Aspect 19. The method of aspect 17, wherein: the sidelink control information indicates the second PSSCH resource; and the transmitting the sidelink data comprises: transmitting the sidelink data in the second PSSCH resource.

Aspect 20. The method of any of aspects 15-19, wherein: the sidelink control information further comprises an indication of an extended region for the first resource region; and the method further comprises: transmitting, during the extended region of the first resource region, another sidelink control information.

Aspect 21. The method of any of aspects 15-20, further comprising: determining to transmit the sidelink control information in the first resource region; and transmitting, based on the determining, a wakeup signal (WUS) in a WUS monitoring occasion associated with the first resource region.

Aspect 22. The method of aspect 21, further comprising: transmitting, to the second UE, a WUS configuration associated with the WUS monitoring occasion.

Aspect 23. The method of any of aspects 15-22, further comprising: determining whether to transmit any sidelink control information in a second resource region of the set of the resource regions; and refraining, based on the determination of whether to transmit, from transmitting a wakeup signal (WUS) in a WUS monitoring occasion associated with the second resource region.

Aspect 24. The method of any of aspects 15-22, wherein the set of the resource regions are within a physical sidelink control channel (PSCCH) resource pool, and wherein the sidelink control information indicates a physical control shared channel (PSSCH) resource for the sidelink data, the PSSCH resource being within a PSSCH resource pool different from the PSCCH resource pool.

Aspect 25. The method of aspect 24, further comprising: determining the PSCCH resource pool from a set of sidelink resources; and determining the PSSCH resource pool from the set of sidelink resources.

Aspect 26. The method of aspect 24, wherein the set of the resource regions comprises a subset of resources less than all resources in the PSCCH resource pool.

Aspect 27. The method of aspect 24, wherein the transmitting the sidelink control information indicates a data format for the sidelink data.

Aspect 28. A first user equipment (UE) comprising: a transceiver, at least one processor and a memory comprising codes executable by the at least one processor, configured to perform the actions of one or more of aspects 1-14.

Aspect 29. A first user equipment (UE) comprising: a transceiver, at least one processor and a memory comprising codes executable by the at least one processor, configured to perform the actions of one or more aspects 15-27.

Aspect 30. A first user equipment (UE) comprising means for performing the actions of one or more of aspects 1-14.

Aspect 31. A first user equipment (UE) comprising means for performing the actions of one or more of aspects 15-27.

Aspect 32. An apparatus for wireless communications by a first user equipment (UE), comprising: a memory comprising instructions and at least one processor configured to execute the instructions to obtain, from a second UE, a configuration indicating a set of resource regions spaced apart from each other in time; monitor, in one or more of the set of the resource regions, for sidelink control information; obtain, from the second UE based on the monitoring, the sidelink control information in a first resource region of the set of the resource regions; and obtain, from the second UE based on the sidelink control information, sidelink data.

Aspect 33. An apparatus for wireless communications by a first user equipment (UE), comprising: a memory comprising instructions and at least one processor configured to execute the instructions to: provide, for transmission to a second UE, a configuration indicating a set of resource regions spaced apart from each other in time; provide, for transmission to the second UE, sidelink control information in a first resource region of the set of the resource regions; and provide, for transmission to the second UE based on the sidelink control information, sidelink data.

Aspect 34. A non-transitory, computer readable medium having program code recorded thereon, wherein the program code comprises instructions executable by a first user equipment (UE), the program code comprising: code for receiving, by the first UE from a second UE, a configuration indicating a set of resource regions spaced apart from each other in time; code for monitoring, by the first UE in one or more of the set of the resource regions, for sidelink control information; code for receiving, by the first UE from the second UE based on the monitoring, the sidelink control information in a first resource region of the set of the resource regions; and code for receiving, by the first UE from the second UE based on the sidelink control information, sidelink data.

Aspect 35. A non-transitory, computer readable medium having program code recorded thereon, wherein the program code comprises instructions executable by a first user equipment (UE), the program code comprising: code for transmitting, by the first UE to a second UE, a configuration indicating a set of resource regions spaced apart from each other in time; code for transmitting, by the first UE to the second UE, sidelink control information in a first resource region of the set of the resource regions; and code for transmitting, by the first UE to the second UE based on the sidelink control information, sidelink data.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

Means for receiving or means for obtaining may include a receiver, such as the transceiver 1010 and/or the antenna 1016 of the UE 1000 illustrated in FIG. 10, or the transceiver and/or the antennas 1116 of the BS 1100 illustrated in FIG. 11. Means for transmitting or means for outputting may include a transmitter such the transceiver 1010 and/or the antenna 1016 of the UE 1000 illustrated in FIG. 10, or the transceiver and/or the antennas 1116 of the BS 1100 illustrated in FIG. 11. Means for detecting, means for forwarding, means for determining, means for refraining and/or means for performing may include a processing system, which may include one or more processors, such as the processor 1002 of the UE 1000, or the processor 1102 of the BS 1100.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining) For example, a processor may obtain (or receive) a frame, via a bus interface, from an RF front end for reception.

As those of some skill in this art will by now appreciate and depending on the particular application at hand, many modifications, substitutions and variations can be made in and to the materials, apparatus, configurations and methods of use of the devices of the present disclosure without departing from the scope thereof. In light of this, the scope of the present disclosure should not be limited to that of the particular embodiments illustrated and described herein, as they are merely by way of some examples thereof, but rather, should be fully commensurate with that of the claims appended hereafter and their functional equivalents.

What is claimed is:

1. A method of wireless communication performed by a first user equipment (UE), the method comprising:
receiving, from a second UE, a configuration indicating a set of resource regions spaced apart from each other in time;
monitoring, in one or more of the resource regions, for sidelink control information;
receiving, from the second UE based on the monitoring, the sidelink control information in a first resource region of the set of the resource regions; and
receiving, from the second UE based on the sidelink control information, sidelink data.

2. The method of claim 1, wherein the set of the resource regions is associated with a monitoring periodicity.

3. The method of claim 1, wherein the receiving the sidelink control information comprises:
receiving, from the second UE in a physical sidelink control channel (PSCCH) resource within the first resource region, the sidelink control information, wherein the sidelink control information indicates at least one of:
a first physical sidelink shared channel (PSSCH) resource within the first resource region; or
a second PSSCH resource outside the first resource region.

4. The method of claim 3, wherein:
the sidelink control information indicates the first PSSCH resource; and
the receiving the sidelink data comprises:
receiving the sidelink data in the first PSSCH resource.

5. The method of claim 3, wherein:
the sidelink control information indicates the second PSSCH resource; and
the receiving the sidelink data comprises:
receiving the sidelink data in the second PSSCH resource.

6. The method of claim 1, wherein:
the sidelink control information comprises an indication of an extended region for the first resource region; and
the method further comprises:
monitoring, during the extended region of the first resource region, for another sidelink control information.

7. The method of claim 1, further comprising:
monitoring for a wakeup signal (WUS),
wherein the monitoring the first resource region is based on the WUS being detected via the monitoring.

8. The method of claim 7, wherein the WUS is over a WUS monitoring occasion associated with the first resource region.

9. The method of claim 8, further comprising:
receiving, from the second UE, a WUS configuration associated with the WUS monitoring occasion,
wherein the monitoring for the WUS is based on the WUS configuration.

10. The method of claim 1, further comprising:
monitoring for a wakeup signal (WUS) associated with a second resource region of the set of the resource regions; and
refraining from monitoring the second resource region if no WUS is detected base on the WUS monitoring.

11. The method of claim 1, further comprising:
determining, from the monitoring, that there is no sidelink control information detected in a second resource region of the set of the resource regions; and
configuring, based on the determining, the first UE to operate in a sleep mode until one or more occurrences of a next wakeup signal (WUS) monitoring occasion and a next resource region of the set of the resource regions.

12. The method of claim 1, wherein the set of the resource regions are within a physical sidelink control channel (PSCCH) resource pool, and wherein the sidelink control information indicates a physical control shared channel (PSSCH) resource for the sidelink data, the PSSCH resource being within a PSSCH resource pool different from the PSCCH resource pool.

13. The method of claim 12, wherein the set of the resource regions comprises a subset of resources less than all resources in the PSCCH resource pool.

14. The method of claim 1, wherein the receiving the sidelink control information comprises:
receiving the sidelink control information indicating a data format for the sidelink data.

15. A method of wireless communication performed by a first user equipment (UE), the method comprising:
transmitting, to a second UE, a configuration indicating a set of resource regions spaced apart from each other in time;
transmitting, to the second UE, sidelink control information in a first resource region of the set of the resource regions; and
transmitting, to the second UE based on the sidelink control information, sidelink data.

16. The method of claim 15, wherein the set of the resource regions is associated with a monitoring periodicity.

17. The method of claim 15, wherein the transmitting the sidelink control information comprises:
transmitting, to the second UE in a physical sidelink control channel (PSCCH) resource within the first resource region, wherein the sidelink control information indicates at least one of:
a first physical sidelink shared channel (PSSCH) resource within the first resource region; or
a second PSSCH resource outside the first resource region.

18. The method of claim 17, wherein:
the sidelink control information indicates the first PSSCH resource; and
the transmitting the sidelink data comprises:
transmitting the sidelink data in the first PSSCH resource.

19. The method of claim 17, wherein:
the sidelink control information indicates the second PSSCH resource; and
the transmitting the sidelink data comprises:
transmitting the sidelink data in the second PSSCH resource.

20. The method of claim 15, wherein:
the sidelink control information comprises an indication of an extended region for the first resource region; and
the method further comprises:
transmitting, during the extended region of the first resource region, another sidelink control information.

21. The method of claim 15, further comprising:
determining to transmit the sidelink control information in the first resource region; and
transmitting, based on the determining, a wakeup signal (WUS) in a WUS monitoring occasion associated with the first resource region.

22. The method of claim 21, further comprising:
transmitting, to the second UE, a WUS configuration associated with the WUS monitoring occasion.

23. The method of claim 22, further comprising:
determining whether to transmit any sidelink control information in a second resource region of the set of resource regions; and
refraining, based on the determination of whether to transmit, from transmitting a wakeup signal (WUS) in a WUS monitoring occasion associated with the second resource region.

24. The method of claim 15, wherein the resource regions of the set are within a physical sidelink control channel (PSCCH) resource pool, and wherein the sidelink control information indicates a physical control shared channel (PSSCH) resource for the sidelink data, the PSSCH resource being within a PSSCH resource pool different from the PSCCH resource pool.

25. The method of claim 24, further comprising:
determining the PSCCH resource pool from a set of sidelink resources; and
determining the PSSCH resource pool from the set of sidelink resources.

26. The method of claim 24, wherein the set of resource regions comprises a subset of resources less than all resources in the PSCCH resource pool.

27. The method of claim 24, wherein the sidelink control information indicates a data format for the sidelink data.

28. A first user equipment (UE) comprising:
at least one processor configured to:
monitor, in one or more resource regions of a set of resource regions, for sidelink control information; and
a transceiver configured to:
receive, from a second UE, a configuration indicating the set of resource regions spaced apart from each other in time;
receive, from the second UE based on the monitoring, the sidelink control information in a first resource region of the set of sidelink control information monitoring resource regions; and
receive, from the second UE based on the sidelink control information, sidelink data.

29. The first UE of claim 28, wherein the transceiver is further configured to:
receive, from the second UE in a physical sidelink control channel (PSCCH) resource within the first sidelink control information monitoring resource region, the sidelink control information indicating at least one of:
a first physical sidelink shared channel (PSSCH) resource within the first sidelink control information monitoring resource region; or
a second PSSCH resource outside the first sidelink control information monitoring resource region.

30. A first user equipment (UE) comprising:
a transceiver configured to:
transmit, to a second UE, a configuration indicating a set of resource regions spaced apart from each other in time;
transmit to the second UE, the sidelink control information in a first resource region of the set of the resource regions; and
transmit, to the second UE based on the sidelink control information, sidelink data.
